(19) United States
(12) Patent Application Publication
(10) Pub. No.: US 2026/0132156 A1
(43) Pub. Date: May 14, 2026

(54) METHODS FOR PURIFYING TIN COMPOUND

(71) Applicants: Mitsubishi Chemical Corporation, Tokyo (JP); Gelest, Inc., Morrisville, PA (US)

(72) Inventors: Takuya TOKUMI, Tokyo (JP); Koki ISHII, Tokyo (JP); Yuta HIOKI, Tokyo (JP); Kazuhiro KUWABARA, Tokyo (JP); Shigeo YASHIMA, Tokyo (JP); Yasuhiro OKUNO, Tokyo (JP); Mari TAKAKI, Tokyo (JP); Shota WATANABE, Tokyo (JP); Tsuyoshi NAGASAKA, Tokyo (JP); Eric Anthony ROBERTSON, III, Easton, PA (US); Brandon Christopher DECICCO, Morrisville, PA (US)

(21) Appl. No.: 19/440,849

(22) Filed: Jan. 6, 2026

Related U.S. Application Data
(62) Division of application No. 18/960,612, filed on Nov. 26, 2024.
(60) Provisional application No. 63/604,212, filed on Nov. 30, 2023.
(60) Provisional application No. 63/632,247, filed on Apr. 10, 2024.

(51) Int. Cl. C07F 7/22; B01D 3/32; B01D 3/42

(52) U.S. Cl. CPC C07F 7/2296; B01D 3/32; B01D 3/4205; C07F 7/2284

(57) ABSTRACT

A method for producing a tin compound represented by formula (A1) with a purity of 95 mol % or higher, involves a step of distilling the tin compound, in which the number of plates of the distillation is 10 or more, and the reflux ratio is 30 or less.

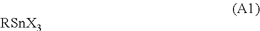

In formula (A1), R is an organic group with 1 to 30 carbon atoms, and may be substituted with halogen, oxygen atoms, or nitrogen atoms. X is selected from OR′ and NR′₂. R′is an organic group with 1 to 10 carbon atoms, and part may be substituted with halogen, oxygen atoms, or nitrogen atoms. When there are multiple R′ groups in the molecule, they may have the same or different structures, and they may be bonded to each other to form a cyclic structure.

### CROSS-REFERENCE TO RELATED APPLICATIONS

This application claims priority to co-pending U.S. Provisional Patent Application No. 63/604,212, filed Nov. 30, 2023, and co-pending U.S. Provisional Patent Application No. 63/632,247, filed Apr. 10, 2024, the disclosures of which are herein incorporated by reference in their entireties.

### SUMMARY OF THE INVENTION

### Technical Field

The present invention relates to a method for producing tin compounds.

### BACKGROUND ART

In recent years, with the paradigm shift to a highly information-oriented society, there is a demand for handling more information at higher speeds and with higher accuracy, and the technology related to semiconductor devices such as integrated circuits using semiconductors is advancing rapidly day by day.

The evolution of semiconductor design requires the formation of extremely fine features on semiconductor substrate materials, and individual features are approximately 22 nanometers (nm) or less, and in some cases, they can be less than 10 nm. One of the challenges in manufacturing devices with such fine features is the ability to reliably and reproducibly form photolithography masks with sufficient resolution. Achieving feature sizes smaller than the wavelength of light requires the use of complex high-resolution technologies such as multi-patterning. Therefore, the development of photolithography technology using extreme ultraviolet (EUV) radiation with a shorter wavelength of 10 nm to 15 nm (e.g., 13.5 nm) is of great importance.

Conventional organic chemical amplification resists (CAR) have potential drawbacks when used in EUV lithography, especially in the EUV region, as they have low absorption coefficients and may exhibit blurring of light-activated chemical species diffusion or line edge roughness. Therefore, there remains a need for improved EUV photoresist materials with thin thickness, better absorption, and better etching resistance.

For this reason, liquid chemical vapor deposition (CVD) materials such as organic tin have recently begun to be used as resists, especially for EUV applications, and extremely high-purity materials are required to achieve high-quality film formation. Therefore, among organic tin compounds, monomethyl tin compounds having one organic group are used preferably, and impurities such as water, residual solvents used in synthesis, and metal impurities are removed by distillation or the like before use as CVD materials (Patent Literature 1).

Organic tin compounds are known to generate by-products due to side reactions such as thermal disproportionation. In particular, monomethyl tin compounds are prone to decomposition, and it was difficult to obtain high-purity tin compounds through distillation processes involving heating. Previously disclosed distillation methods for obtaining high-purity monomethyl tin compounds include methods using distillation columns with high theoretical plate numbers or methods involving multiple distillations (Patent Literature 2).

### PRIOR ART DOCUMENTS

### Patent Documents

[Patent Literature 1] JP 2020-122959 A
[Patent Literature 2] JP 2020-530199 A

However, monomethyl tin compounds have multiple distillation purification challenges, such as decomposition occurring at the temperature required for distillation, a high decomposition rate, and the need for highly efficient distillation due to the close boiling points of impurities and the target product. Therefore, it was difficult to achieve high-purity and high-productivity production of such monomethyl tin compounds by simply applying previously reported conventional distillation technology. Specifically, when highly efficient distillation was performed using known techniques, high temperatures and long heating times were required, and decomposition occurred during the distillation purification process, resulting in the problem of impurities formed by decomposition being mixed into the distillate.

Additionally, while distillation can improve purity, there is a possibility of trace amounts of halogen atoms and metal elements being mixed in, which can negatively impact the quality of the semiconductor material. Achieving both high purity and low content of metals and halogens was very challenging with conventional technologies. In particular, for organic tin compounds with specific structures, where existing purification methods (such as ultra-pure water washing, column chromatography, and adsorption treatment on resins) that are known to be effective in reducing halogen and metal content cannot be used, there have been no examinations of methods to reduce the content of halogens and metals to the low levels required for resist materials while maintaining high purity.

Therefore, in view of this background, the present invention provides a high-purity tin compound by suppressing the decomposition of monomethyl tin compounds and achieving effective distillation purification.

Additionally, the present invention provides a high-purity tin compound by suppressing the decomposition of monomethyl tin compounds, improving purity through effective distillation purification, and reducing the content of halogens and metals.

### Means for Solving the Problems

The present inventors have conducted intensive research to solve the above problems and found that the above objectives can be achieved by employing specific conditions and steps in the distillation method.

That is, the present invention has the following embodiments.

In one embodiment, aspects of the disclosure relate to a method for producing a tin compound having formula (A1) and having a purity of 95 mol % or more, the method comprising a step of distilling the tin compound,
wherein in the distillation step, a number of distillation plates is 10 or more and a reflux ratio is 30 or less:

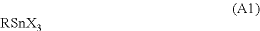

wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms, when there are multiple R′ groups in the molecule, they may be the same or different in structure, and they may also be bonded to form a cyclic structure.

Further embodiments of the disclosure are directed to a method for producing a tin compound having formula (A1) and having a purity of 95 mol % or more, the method comprising a step of distilling the tin compound,
wherein the distillation step includes the following operations 1 and 2:

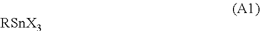

wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms; when there are multiple R′ groups in the molecule, they may be the same or different in structure, and they may also be bonded to form a cyclic structure.
   operation 1:
withdrawing an initial distillate, which corresponds to 0.1-50% by mass of a total distillate, under conditions when a reflux ratio is less than or equal to 1;
   operation 2:
withdrawing a remaining distillate, excluding the initial distillate from operation 1, under conditions when the reflux ratio exceeds 1.

Further aspects of the disclosure relate to a method for producing a tin compound having formula (A1) and having a purity of 95 mol % or more, the method comprising a step of distilling the tin compound, wherein the distillation step employs a heating vessel having a heat transfer area of 1.0 cm²/g or less per mass of the tin compound:

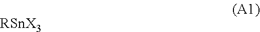

wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms; when there are multiple R′ groups in the molecule, they may be the same or different in structure, and they may also be bonded to form a cyclic structure.

In another embodiment, aspects of the disclosure relate to a method for producing a tin compound having formula (A1) and having a purity of 95 mol % or more, the method comprising a step of distilling the tin compound, wherein the distillation step employs a distillation tower having multiple distillate outlets, and wherein the tin compound (A1) is obtained from a distillate outlet located below the highest outlet in a vertical direction of the distillation tower:

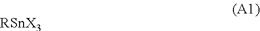

wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms, when there are multiple R′ groups in the molecule, they may be the same or different in structure, and they may also be bonded to form a cyclic structure.

In a further embodiment, aspects of the disclosure relate to a method for producing a tin compound having formula (A1) and having a purity of 95 mol % or more, the method comprising a step of distilling the tin compound, wherein the distillation step employs a packed distillation tower equipped with insulation equipment and/or heating equipment:

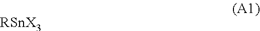

wherein R is an organic group with 1 to 30 carbon atoms, which may be partially substituted with halogen, oxygen, or nitrogen atoms. X is selected from OR′ or NR′₂, R′ is an organic group with 1 to 10 carbon atoms, which may be partially substituted with halogen, oxygen, or nitrogen atoms, when there are multiple R′ groups in the molecule, they may be the same or different in structure, and they may also be bonded to form a cyclic structure.

Additional aspects of the disclosure relate to a tin compound with a purity of 95 mol % or more and having formula (B1), wherein a content of each halogen atom (fluorine, chlorine, bromine, iodine) is 10 ppm or less by mass:

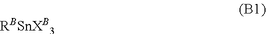

wherein R^{B} is an organic group with 1 to 30 carbon atoms, which may be partially substituted with oxygen or nitrogen atoms, X^{B} is selected from OR′^{B} or NR′₂^{B}, R′^{B} is an organic group with 1 to 10 carbon atoms, which may be partially substituted with oxygen or nitrogen atoms, when there are multiple R′^{B} groups in the molecule, they may be the same or different in structure, and they may also be bonded to form a cyclic structure.

Advantageous refinements of the invention, which can be implemented alone or in combination, are specified in the dependent claims.

In summary, the following embodiments are proposed as particularly preferred in the scope of the present invention:

Embodiment 1: A method for producing a tin compound having formula (A1) and having a purity of 95 mol % or more, the method comprising a step of distilling the tin compound,
wherein in the distillation step, a number of distillation plates is 10 or more and a reflux ratio is 30 or less:

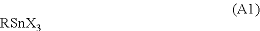

wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms, when there are multiple R′ groups in the molecule, they may be the same or different in structure, and they may also be bonded to form a cyclic structure.

Embodiment 2: The method for producing the tin compound according to Embodiment 1,
wherein the distillation step includes the following operations 1 and 2:
   operation 1:
withdrawing an initial distillate, which corresponds to 0.1-50% by mass of a total distillate, under conditions when a reflux ratio is less than or equal to 1;
   operation 2:
withdrawing a remaining distillate, excluding the initial distillate from operation 1, under conditions when the reflux ratio exceeds 1.

Embodiment 3: The method for producing the tin compound according to Embodiment 1 or 2, wherein the distillation step employs a heating vessel having a heat transfer area of 1.0 cm²/g or less per mass of the tin compound.

Embodiment 4: The method for producing the tin compound according to any one of Embodiments 1 to 3, the method comprising a step of distilling the tin compound, wherein the distillation step employs a distillation tower having multiple distillate outlets, and wherein the tin compound (A1) is obtained from a distillate outlet located below the highest outlet in a vertical direction of the distillation tower.

Embodiment 5: The method for producing the tin compound according to any one of Embodiments 1 to 4, the method comprising a step of distilling the tin compound, wherein the distillation step employs a packed distillation tower equipped with insulation equipment and/or heating equipment.

Embodiment 6: The method for producing the tin compound according to any one of Embodiments 1 to 5, wherein a content of each halogen atom (fluorine, chlorine, bromine, iodine) in the tin compound is 10 ppm or less by mass.

Embodiment 7: The method for producing the tin compound according to any one of Embodiments 1 to 6, wherein a distillation time is 1 to 20 hours.

Embodiment 8: A method for producing a tin compound having formula (A1) and having a purity of 95 mol % or more, the method comprising a step of distilling the tin compound,
wherein the distillation step includes the following operations 1 and 2:

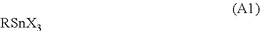

wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms; when there are multiple R′ groups in the molecule, they may be the same or different in structure, and they may also be bonded to form a cyclic structure.
   operation 1:
withdrawing an initial distillate, which corresponds to 0.1-50% by mass of a total distillate, under conditions when a reflux ratio is less than or equal to 1;
   operation 2:
withdrawing a remaining distillate, excluding the initial distillate from operation 1, under conditions when the reflux ratio exceeds 1.

Embodiment 9: The method for producing the tin compound according to Embodiment 8, wherein the distillation step employs a heating vessel having a heat transfer area of 1.0 cm²/g or less per mass of the tin compound.

Embodiment 10: The method for producing the tin compound according to Embodiment 8 or 9, wherein the distillation step employs a distillation tower having multiple distillate outlets, and wherein the tin compound (A1) is obtained from a distillate outlet located below the highest outlet in a vertical direction of the distillation tower.

Embodiment 11: The method for producing the tin compound according to any one of Embodiments 8 to 10, the method comprising a step of distilling the tin compound, wherein the distillation step employs a packed distillation tower equipped with insulation equipment and/or heating equipment.

Embodiment 12: The method for producing the tin compound according to any one of Embodiments 8 to 11, wherein a content of each halogen atom (fluorine, chlorine, bromine, iodine) in the tin compound is 10 ppm or less by mass.

Embodiment 13: The method for producing the tin compound according to any one of Embodiments 8 to 12, wherein a distillation rate in operation 1 is higher than a distillation rate in operation 2.

Embodiment 14: The method for producing the tin compound according to any one of Embodiments 8 to 13, wherein the reflux ratio in operation 2 is 5-100.

Embodiment 15: A method for producing a tin compound having formula (A1) and having a purity of 95 mol % or more, the method comprising a step of distilling the tin compound.
wherein the distillation step employs a heating vessel having a heat transfer area of 1.0 cm²/g or less per mass of the tin compound:

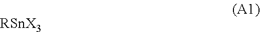

wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms; when there are multiple R′ groups in the molecule, they may be the same or different in structure, and they may also be bonded to form a cyclic structure.

Embodiment 16: The method for producing the tin compound according to Embodiment 15, wherein the distillation step employs a distillation tower having multiple distillate outlets, and wherein the tin compound (A1) is obtained from a distillate outlet located below the highest outlet in a vertical direction of the distillation tower.

Embodiment 17: The method for producing the tin compound according to Embodiment 15 or 16, wherein the distillation step employs a packed distillation tower equipped with insulation equipment and/or heating equipment.

Embodiment 18: The method for producing the tin compound according to any one of Embodiments 15 to 17, wherein a content of each halogen atom (fluorine, chlorine, bromine, iodine) in the tin compound is 10 ppm or less by mass.

Embodiment 19: A method for producing a tin compound having formula (A1) and having a purity of 95 mol % or more, the method comprising a step of distilling the tin compound, wherein the distillation step employs a distillation tower having multiple distillate outlets, and wherein the tin compound (A1) is obtained from a distillate outlet located below the highest outlet in a vertical direction of the distillation tower:

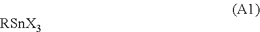

wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms, when there are multiple R′ groups in the molecule, they may be the same or different in structure, and they may also be bonded to form a cyclic structure.

Embodiment 20: The method for producing the tin compound according to Embodiment 19, wherein the distillation step employs a packed distillation tower equipped with insulation equipment and/or heating equipment.

Embodiment 21: The method for producing the tin compound according to Embodiment 19 or 20, wherein a content of each halogen atom (fluorine, chlorine, bromine, iodine) in the tin compound is 10 ppm or less by mass.

Embodiment 22: The method for producing the tin compound according to any one of Embodiments 19 to 21, wherein a ratio of the number of theoretical plates below the highest distillate outlet in the vertical direction of the distillation tower to the total number of plates in the distillation tower is 0.01-0.75.

Embodiment 23: The method for producing the tin compound according to any one of Embodiments 19 to 22, wherein the number of theoretical plates for the distillate outlet located below the highest outlet in the vertical direction of the distillation tower is 1 or more.

Embodiment 24: A method for producing a tin compound having formula (A1) and having a purity of 95 mol % or more, the method comprising a step of distilling the tin compound, wherein the distillation step employs a packed distillation tower equipped with insulation equipment and/or heating equipment:

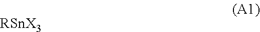

wherein R is an organic group with 1 to 30 carbon atoms, which may be partially substituted with halogen, oxygen, or nitrogen atoms. X is selected from OR′ or NR′₂, R′ is an organic group with 1 to 10 carbon atoms, which may be partially substituted with halogen, oxygen, or nitrogen atoms, when there are multiple R′ groups in the molecule, they may be the same or different in structure, and they may also be bonded to form a cyclic structure.

Embodiment 25: The method for producing the tin compound according to Embodiment 24, wherein a content of each halogen atom (fluorine, chlorine, bromine, iodine) in the tin compound is 10 ppm or less by mass.

Embodiment 26: The method for producing the tin compound according to Embodiment 24 or 25, wherein an HETP (m/plate) of a regular packing material in the distillation tower used in the distillation step is 0.5 or less.

Embodiment 27: The method for producing the tin compound according to any one of Embodiments 1 to 26, wherein the purity of the tin compound having formula (A1) is 98 mol % or more.

Embodiment 28: The method for producing the tin compound according to any one of Embodiments 1 to 27, wherein a content of SnX₄ (A3) is 1 mol % or less.

Embodiment 29: The method for producing the tin compound according to any one of Embodiments 1 to 28, wherein a content of R₂SnX₂ (A2) is 1 mol % or less.

Embodiment 30: The method for producing the tin compound according to any one of Embodiments 1 to 29, wherein a content of a compound having formula (A4) is 1 mol % or less;

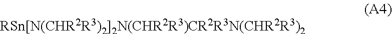

wherein R² and R³ are independently hydrogen atoms or organic groups with 1 to 10 carbon atoms, which may be partially substituted with halogen, oxygen, or nitrogen atoms, and wherein R² and R³ may be bonded to form a cyclic structure.

Embodiment 31: The method for producing the tin compound according to any one of Embodiments 1 to 30, wherein a molecular weight difference between R and X in the tin compound having formula (A1) is 30 or less.

Embodiment 32: The method for producing the tin compound according to any one of Embodiments 1 to 31, wherein the distillation step is performed as a batch distillation.

Embodiment 33: The method for producing the tin compound according to any one of Embodiments 1 to 32, wherein the packing material in the distillation tower used in the distillation step is a regular packing material.

Embodiment 34: The method for producing the tin compound according to any one of Embodiments 1 to 33, wherein an HETP (m/plate) of the packing material in the distillation tower used in the distillation step is 0.5 or less.

Embodiment 35: The method for producing the tin compound according to any one of Embodiments 1 to 34, wherein a distillation tower used in the distillation step is equipped with insulation equipment and/or heating equipment.

Embodiment 36: The method for producing the tin compound according to any one of Embodiments 1 to 35, wherein a difference between the jacket temperature and the distillation temperature (internal temperature) in the distillation step is 3-40° C.

Embodiment 37: The method for producing the tin compound according to any one of Embodiments 1 to 36, wherein a distillation temperature in the distillation step is 50° C. or higher.

Embodiment 38: The method for producing the tin compound according to any one of Embodiments 1 to 37, wherein the distillation step is performed under a reduced pressure of 10 torr or less.

Embodiment 39: The method for producing the tin compound according to any one of Embodiments 1 to 38, wherein a cooling condenser with a temperature 10-70° C. lower than a boiling point of the tin compound having formula (A1) is used in the distillation step.

Embodiment 40: The method for producing the tin compound according to any one of Embodiments 1 to 39, wherein a stirring speed in the distillation step is 100 rpm or more.

Embodiment 41: The method for producing the tin compound according to any one of Embodiments 1 to 40, wherein a distillation time in the distillation step is 10-100 hours.

Embodiment 42: The method for producing the tin compound according to any one of Embodiments 1 to 41, wherein a distillation rate in the distillation step is 1%/h or more,
wherein the distillation rate is based on an extraction rate:

$$Extraction rate ( \% ) = Extraction mass ( g ) / Charged mass ( g ) \times 100$$

$$Distillation rate ( \% / h ) = Extraction rate ( \% ) / Extraction time ( h )$$

Embodiment 43: The method for producing the tin compound according to any one of Embodiments 1 to 42, wherein the distillation step is performed under light-shielding conditions.

Embodiment 44: The method for producing the tin compound according to any one of Embodiments 1 to 43, wherein the tin compound obtained after the distillation step is filled into a storage container under an inert atmosphere.

Embodiment 45: A tin compound with a purity of 95 mol % or more and having formula (B1), wherein the content of each halogen atom (fluorine, chlorine, bromine, iodine) is 10 ppm or less by mass:

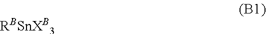

wherein R^{B} is an organic group with 1 to 30 carbon atoms, which may be partially substituted with oxygen or nitrogen atoms, X^{B} is selected from OR′^{B} or NR′₂^{B}, R′^{B} is an organic group with 1 to 10 carbon atoms, which may be partially substituted with oxygen or nitrogen atoms, when there are multiple R′^{B} groups in the molecule, they may be the same or different in structure, and they may also be bonded to form a cyclic structure.

Embodiment 46: The tin compound according to Embodiment 45, wherein a content of chlorine atoms is 5 ppm or less by mass.

Embodiment 47: The tin compound according to Embodiment 45 or 46, wherein a content of metals other than tin is 10 ppb or less by mass.

Embodiment 48: The tin compound according to any one of Embodiments 45 to 47, wherein a purity of the tin compound having formula (B1) is 98 mol % or more.

Embodiment 49: The tin compound according to any one of Embodiments 45 to 48, wherein a content of a compound having formula (B3) is 1 mol % or less;

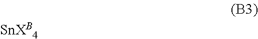

wherein X^{B} is selected from OR′^{B} or NR′₂^{B}, R′^{B} is an organic group with 1 to 10 carbon atoms, which may be partially substituted with oxygen or nitrogen atoms, when there are multiple R′^{B} groups in the molecule, they may be different in structure, and they may also be bonded to form a cyclic structure.

Embodiment 50: The tin compound according to any one of Embodiments 45 to 49, wherein a content of a compound having formula (B2) is 1 mol % or less

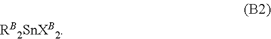

Embodiment 51: The tin compound according to any one of Embodiments 45 to 50, wherein a content of a compound having formula (B4) is 1 mol % or less:

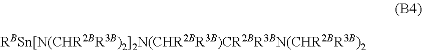

wherein R^{B} is an organic group with 1 to 30 carbon atoms, which may be partially substituted with oxygen or nitrogen atoms, R^{2B} and R^{3B} are independently hydrogen atoms or organic groups with 1 to 10 carbon atoms, which may be partially substituted with oxygen or nitrogen atoms, R^{2B} and R^{3B} may be the same or different, and they may also be bonded to form a cyclic structure.

Embodiment 52: The tin compound according to any one of Embodiments 45 to 51, wherein a molecular weight difference between R^{B} and X^{B} in the tin compound having formula (B1) is 30 or less.

Embodiment 53: A method for producing a tin compound with a purity of 95 mol % or more and having formula (B1), the method comprising a step of distilling the tin compound,
wherein a content of each halogen atom (fluorine, chlorine, bromine, iodine) is 10 ppm or less by mass:

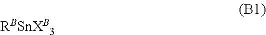

wherein R^{B} is an organic group with 1 to 30 carbon atoms, which may be partially substituted with oxygen or nitrogen atoms, X^{B} is selected from OR′^{B} or NR′₂^{B}, R′^{B} is an organic group with 1 to 10 carbon atoms, which may be partially substituted with oxygen or nitrogen atoms, when there are multiple R′^{B} groups in the molecule, they may be the same or different in structure, and they may also be bonded to form a cyclic structure.

Embodiment 54: The method for producing the tin compound according to Embodiment 53, wherein a content of chlorine atoms is 5 ppm or less by mass.

Embodiment 55: The method for producing the tin compound according to Embodiment 53 or 54, wherein a content of metals other than tin is 10 ppb or less by mass.

Embodiment 56: The method for producing the tin compound according to any one of Embodiments 53 to 55, wherein the distillation step includes the following operations 1 and 2:

operation 1:
withdrawing an initial distillate, which corresponds to 0.1-50% by mass of a total distillate, under conditions when a reflux ratio is less than or equal to 1;
   operation 2:
withdrawing a remaining distillate, excluding the initial distillate from operation 1, under conditions when the reflux ratio exceeds 1.

Embodiment 57: The method for producing the tin compound according to any one of Embodiments 53 to 56, wherein a distillation rate of the operation 1 is higher than a distillation rate of the operation 2,
wherein the distillation rate is based on an extraction rate:

$$Extraction rate ( \% ) = Extraction mass ( g ) / Charged mass ( g ) \times 100$$

$$Distillation rate ( \% / h ) = Extraction rate ( \% ) / Extraction time ( h )$$

Embodiment 58: The method for producing the tin compound according to any one of Embodiments 56 or 57, wherein a reflux ratio in the operation 2 is 5 to 100.

Embodiment 59: The method for producing the tin compound according to any one of Embodiments 53 to 58, wherein the purity of the tin compound having formula (B1) is 98 mol % or more.

Embodiment 60: The method for producing the tin compound according to any one of Embodiments 53 to 59, wherein a content of SnX₄^{B} (B3) is 1 mol % or less;
wherein X^{B} is selected from OR′^{B} or NR′₂^{B}, R′^{B} is an organic group with 1 to 10 carbon atoms, which may be partially substituted with oxygen or nitrogen atoms, when there are multiple R′^{B} groups in the molecule, they may be different in structure, and they may also be bonded to form a cyclic structure.

Embodiment 61: The method for producing the tin compound according to any one of Embodiments 53 to 60, wherein a content of R₂^{B}SnX₂^{B} (B2) is 1 mol % or less.
wherein R^{B} is an organic group with 1 to 30 carbon atoms, which may be partially substituted with oxygen or nitrogen atoms, X^{B} is selected from OR′^{B} or NR′₂^{B}, R′^{B} is an organic group with 1 to 10 carbon atoms, which may be partially substituted with oxygen or nitrogen atoms, when there are multiple R′^{B} groups in the molecule, they may be the same or different in structure, and they may also be bonded to form a cyclic structure.

Embodiment 62: The method for producing the tin compound according to any one of Embodiments 53 to 61, wherein a content of a compound having formula (B4) is 1 mol % or less:

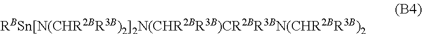

wherein R^{B} is an organic group with 1 to 30 carbon atoms, which may be partially substituted with oxygen or nitrogen atoms, R^{2B} and R^{3B} are independently hydrogen atoms or organic groups with 1 to 10 carbon atoms, which may be partially substituted with oxygen or nitrogen atoms, R^{2B} and R^{3B} may be the same or different, and they may also be bonded to form a cyclic structure.

Embodiment 63: The method for producing the tin compound according to any one of Embodiments 53 to 62, wherein a molecular weight difference between R^{B} and X^{B} in the tin compound having formula (B1) is 30 or less.

Embodiment 64: The method for producing the tin compound according to any one of Embodiments 53 to 63, wherein the distillation step is performed as a batch distillation.

Embodiment 65: The method for producing the tin compound according to any one of Embodiment 53 to 64, wherein the distillation equipment used in the distillation is washed with a solvent containing an alcohol before use for the distillation of the tin compounds.

Embodiment 66: The method for producing the tin compound according to any one of Embodiments 53 to 65, wherein the packing material in the distillation tower used in the distillation step is a regular packing material.

Embodiment 67: The method for producing the tin compound according to any one of Embodiments 53 to 66, wherein an HETP (m/plate) of the packing material in the distillation tower used in the distillation step is 0.5 or less.

Embodiment 68: The method for producing the tin compound according to any one of Embodiments 53 to 67, wherein a distillation tower used in the distillation step is equipped with insulation equipment and/or heating equipment.

Embodiment 69: The method for producing the tin compound according to any one of Embodiments 53 to 68, wherein a difference between the jacket temperature and the distillation temperature (internal temperature) in the distillation step is 3-40° C.

Embodiment 70: The method for producing the tin compound according to any one of Embodiments 53 to 69, wherein a distillation temperature in the distillation step is 50° C. or higher.

Embodiment 71: The method for producing the tin compound according to any one of Embodiments 53 to 70, wherein the distillation step is performed under a reduced pressure of 10 torr or less.

Embodiment 72: The method for producing the tin compound according to any one of Embodiments 53 to 71, wherein a cooling condenser with a temperature 10-70° C. lower than a boiling point of the tin compound having formula (B1) is used in the distillation step.

Embodiment 73: The method for producing the tin compound according to any one of Embodiments 53 to 72, wherein a stirring speed in the distillation step is 100 rpm or more.

Embodiment 74: The method for producing the tin compound according to any one of Embodiments 53 to 73, wherein the distillation time for the distillation is 10 to 100 hours.

Embodiment 75: The method for producing the tin compound according to any one of Embodiments 53 to 74, wherein a distillation rate in the distillation step is 1%/h or more,
wherein the distillation rate is based on an extraction rate:

$$Extraction rate ( \% ) = Extraction mass ( g ) / Charged mass ( g ) \times 100$$

$$Distillation rate ( \% / h ) = Extraction rate ( \% ) / Extraction time ( h )$$

Embodiment 76: The method for producing the tin compound according to any one of Embodiments 53 to 75, wherein the distillation is carried out under light-shielding conditions.

Embodiment 77: The method for producing the tin compound according to any one of Embodiments 53 to 76, wherein the purified tin compounds are filled into a storage container in an inert atmosphere.

Embodiment 78: The method for producing the tin compound according to any one of Embodiments 53 to 77, wherein in the distillation step, a number of distillation plates is 10 or more and a reflux ratio is 30 or less:

Embodiment 79: The method for producing the tin compound according to any one of Embodiments 53 to 78, wherein the distillation step employs a heating vessel having a heat transfer area of 1.0 cm²/g or less per mass of the tin compound.

Embodiment 80: The method for producing the tin compound according to any one of Embodiments 53 to 79, the method comprising a step of distilling the tin compound, wherein the distillation step employs a distillation tower having multiple distillate outlets, and wherein the tin compound (A1) is obtained from a distillate outlet located below the highest outlet in a vertical direction of the distillation tower.

### Effects of the Invention

The method for purifying tin compounds according to the present invention makes it possible to obtain a specific high-purity tin compound by suppressing the decomposition of monomethyl tin compounds and performing effective distillation purification.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a reference diagram of a distillation apparatus for obtaining tin compounds according to one embodiment of the present invention.

### DETAILED DESCRIPTION OF THE INVENTION

The present invention will be described below based on examples of embodiments for carrying out the invention. However, the present invention is not limited to the following embodiments.

In the present invention, when expressing “Y to Z” (Y and Z are arbitrary numbers), unless otherwise specified, it includes the meaning of “Y or more and Z or less” as well as the meaning of “preferably greater than Y” or “preferably less than Z”.

Also, when expressing “Y or more” (Y is an arbitrary number) or “Z or less” (Z is an arbitrary number), it includes the meaning of “it is preferable to be greater than Y” or “it is preferable to be less than Z”. Furthermore, in the present invention, “y and/or z (y and z are arbitrary components or components)” means three combinations of y only, z only, and y and z. Unless otherwise stated, the term “about” is to be understood as a numerical value typically includes +10% of the recited value. For example, the recitation of a temperature such as “10° C.” or “about 10° C.” includes 9° C. and 11° C. and all temperatures there between. All numerical ranges expressed in this disclosure expressly encompass all possible subranges, all individual numerical values within that range, including integers within such ranges and fractions and decimal amounts of the values unless the context clearly indicates otherwise.

Regarding the numerical ranges described in a stepwise manner in the present specification, the upper limit value or lower limit value of one numerical range can be arbitrarily combined with the upper limit value or lower limit value of another numerical range. In addition, the upper limit value or lower limit value of the numerical range described in the present specification can be replaced with the value shown in the example.

The following describes in detail a method for purifying tin compounds according to one embodiment or aspect of the present invention (hereinafter referred to as “the present purification method” in some cases). For convenience, the unpurified tin compound is referred to as “crude tin compound”, and the tin compound purified by the present purification method is referred to as “purified tin compound” in some cases.

The tin compound (crude tin compound) to be subjected to the present purification method is a liquid tin mixture containing at least another tin compound as a main component, represented by the following general formula (A1). Other tin compounds include, for example, by-products obtained in the process of synthesizing tin compounds, and decomposition products of tin compounds generated during the storage process.

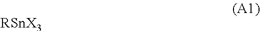

In general formula (A1), R is an organic group with 1 to 30 carbon atoms, which may be partially substituted with halogen, oxygen, or nitrogen atoms. X is selected from OR′ or NR′₂. R′ is an organic group with 1 to 10 carbon atoms, which may be partially substituted with halogen, oxygen, or nitrogen atoms. When there are multiple R′ groups in the molecule, they may be different in structure, and they may also be bonded to form a cyclic structure.

Here, the main component refers to a component that has a significant impact on the characteristics of the subject, and the content of that component, excluding volatile components such as solvents, is usually 50% by mass or more, preferably 55% by mass or more, more preferably 60% by mass or more, further preferably 70% by mass or more, and particularly preferably 80% by mass. Note that the content of the tin compound represented by the following general formula (A1) in the crude tin compound is usually less than 95% by mass.

The present purification method is a method for purifying crude tin compounds containing tin compound A1, which is the main component represented by the above general formula (A1), to a high purity of 95 mol % or more by distillation, and it is possible to obtain high-purity tin compound A1 by the specific distillation method and conditions described below.

First, the following describes tin compound A1, which is the target substance for purification. Impurities other than tin compound A1 will be described later.

### <Tin Compound A1>

Tin compound A1, which is the target compound of the present invention, is defined as follows. It is a compound in which one organic group and three reactive substituents X capable of reacting with hydrolysis or the like are bonded to tetravalent tin. Specifically, it is represented by the following general formula (A1).

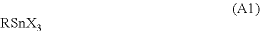

In general formula (A1), R is an organic group with 1 to 30 carbon atoms, which may be partially substituted with halogen, oxygen, or nitrogen atoms. X is selected from OR′ or NR′₂. R′ is an organic group with 1 to 10 carbon atoms, which may be partially substituted with halogen, oxygen, or nitrogen atoms. When there are multiple R′ groups in the molecule, they may be different in structure, and they may also be bonded to form a cyclic structure.

Among the compounds represented by the above general formula (A1), a compound that does not substantially contain halogen atoms in the molecule is represented by the following general formula (B1).

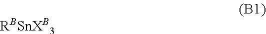

In general formula (B1), R^{B} is an organic group with 1 to 30 carbon atoms, which may be partially substituted with oxygen or nitrogen atoms. X^{B} is selected from OR′^{B} or NR′B. R′^{B} is an organic group with 1 to 10 carbon atoms, which may be partially substituted with oxygen or nitrogen atoms. When there are multiple R′^{B} groups in the molecule, they may be different in structure, and they may also be bonded to form a cyclic structure. R^{B} and X^{B} are substituent groups that are not substituted with halogen atoms.

The phrase “substantially free of halogen atoms” means that the content of each halogen atom (fluorine, chlorine, bromine, iodine) in the tin compound after purification is 10 ppm or less by mass, and it is preferable that the content of chlorine atoms is 5 ppm or less by mass. It is also preferable that the content of metals other than tin in the tin compound after purification is 10 ppb or less by mass, and more preferably 5 ppb or less by mass.

Since the general formula (A1) and the general formula (B1) are essentially the same except for the difference in the amount of halogen atoms in the molecule, the following can be read as “R^{B}”, “R′^{B}”, and “X^{B}” in the general formula (B1) instead of “R”, “R”, and “X” in the general formula (A1).

### [Substituent R]

Substituent R is an organic group with 1 to 30 carbon atoms, which may be partially substituted with halogen, oxygen atoms, nitrogen atoms, or other heteroatoms. Considering the ease of R-base detachment and volatilization of the generated R component during EUV exposure, the number of carbon atoms in R is preferably 30 or less, more preferably 20 or less, and even more preferably 10 or less as an upper limit. From the viewpoint of the stability of the dissociated component, the lower limit is 1 or more, preferably 2 or more, and more preferably 3 or more.

Substituent R may also be partially substituted with O, N, halogen, or other heteroatoms, including heteroatoms may result in higher decomposition properties against EUV light and improved resist performance such as sensitivity.

Some preferred specific examples of substituent R include methyl, ethyl, propyl, isopropyl, butyl, isobutyl, sec-butyl, tert-butyl, pentyl, hexyl, cyclopentyl, cyclohexyl, and other alkyl groups; phenyl, triyl, naphthyl, and other aryl groups; benzyl, phenethyl, α-methylbenzyl, 2-phenyl-2-propyl, and other aralkyl groups; vinyl, 1-propenyl, allyl, 3-butenyl, and other alkenyl groups; 2-fluoroethyl, 2-iodoethyl, and other halogen-substituted alkyl groups, etc.

Further examples of the structure include the following compounds. In these formulas, Ra and R^{b} are organic groups with 1 to 10 carbon atoms, which may be partially substituted with halogen, oxygen atoms, nitrogen atoms, or other heteroatoms. Substituent A on the aromatic ring is a halogen atom or an organic substituent with 1 to 10 carbon atoms, which may be partially substituted with O or N atoms.

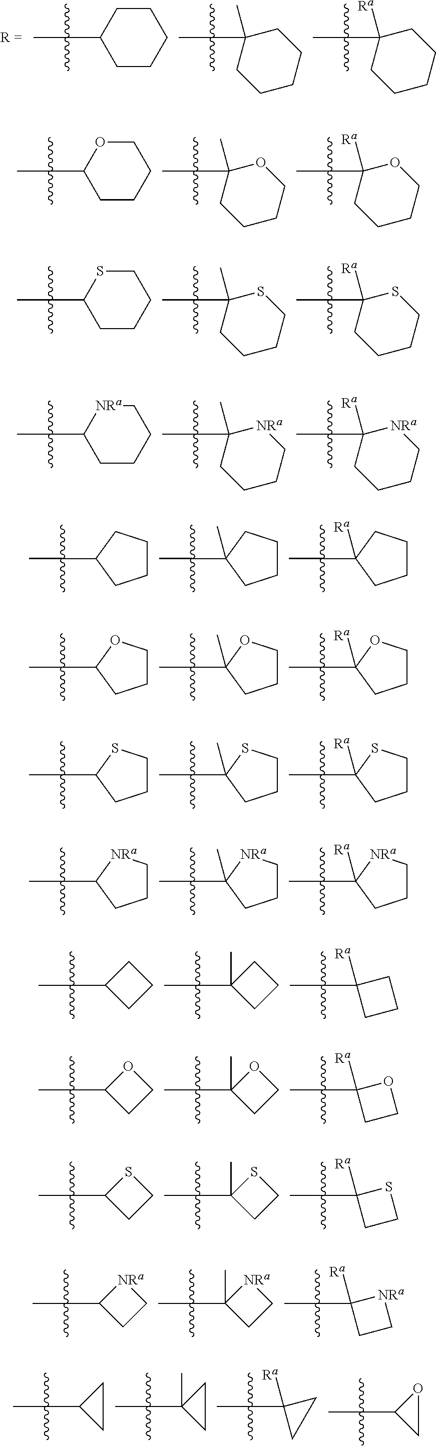

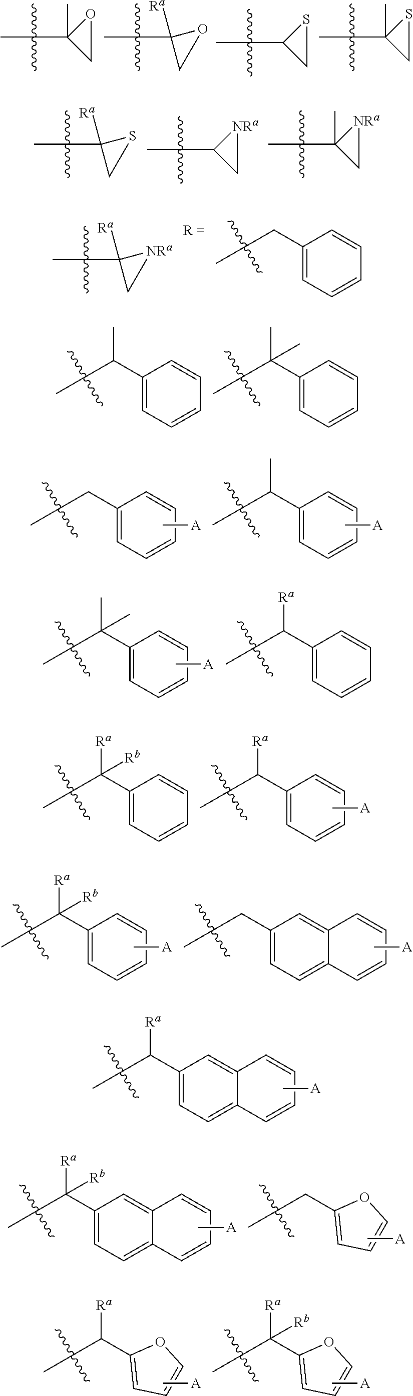

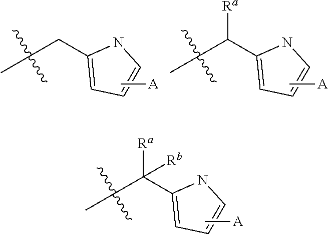

The substituent R shown above can be classified into first-order substituents R¹, second-order substituent R², and third-order substituent R³, and is typically an alkyl group or an aralkyl group. Some preferred examples of each classification are: first-order substituents R¹: methyl, ethyl, n-propyl, n-butyl, isobutyl, benzyl, phenethyl, etc.; second-order substituents R²: isopropyl, sec-butyl, cyclopentyl, cyclohexyl, cycloheptyl, a-methylbenzyl, etc.; third-order substituents R³: tert-butyl, tert-amyl, 1-methyl-cyclopentyl, 1-methyl-cyclohexyl, 2-phenyl-2-propyl, etc. Each may exhibit different characteristics when used as a resist material. The following describes alkyl groups as representative examples, and from the perspective of sensitivity (photoreactivity) when used as a preferred EUV resist, second-order alkyl groups R² and third-order alkyl groups R³ are preferred as they are easily dissociated. From the perspective of hydrophobicity, third-order alkyl groups R³ are the most effective in increasing hydrophobicity near the tin atom, which is preferred from the perspective of controlling solubility, but if the hydrophobicity is too high, second-order alkyl groups R² may be preferred in some cases. From the perspective of thermal stability, which affects distillation and other processes, first-order alkyl groups tend to be less prone to disproportionation and may be easily purified in some cases. On the other hand, second- and third-order alkyl groups are more prone to disproportionation reactions, and in particular, second- and third-order alkyl groups with a low number of carbon atoms (6 or less) are often unstable and difficult during distillation.

### [Substituent X]

Substituent X may have any structure as long as it can undergo reactions such as hydrolysis, but some preferred specific examples are OR′ or NR′ due to their high reactivity. R′ is an organic group with 1 to 10 carbon atoms, which may be partially substituted with halogen, oxygen atoms, nitrogen, or other heteroatoms. When there are multiple R′ groups in the molecule, they may be the same or different in structure, and they may also be bonded to form a cyclic structure. As examples of substituents having an OR′ structure, alkoxy groups, carboxy groups, etc. can be mentioned, and as examples of substituents having an NR′₂ structure, dialkylamino groups, amide groups, etc. can be mentioned. Among them, alkoxy groups and dialkylamino groups are preferred due to their high reactivity in hydrolysis. Some specific examples of substituent R′ include methyl, ethyl, propyl, isopropyl, butyl, isobutyl, sec-butyl, tert-butyl, tert-amyl, 2-methyl-pentyl, trifluoroethyl, trifluoromethyl, etc. As examples of NR′₂, 1 -pyrrolidinyl, in which the two substituents on nitrogen are bonded to form a 5-membered ring, etc. can be mentioned.

Some preferred examples of substituent X include alkyl groups or alkyl groups containing fluorine as substituent R′, which are preferred from the perspective of low boiling point and stability. From the perspective of low boiling point, those with a small number of carbon atoms are preferred, while from the perspective of thermal stability and stability against moisture, those with a large number of carbon atoms are preferred. Some specific examples of substituent X that excel in balancing these characteristics include: OR′: tert-butoxy, tert-amyloxy, 2-methyl-pentyloxy, trifluoroethoxy, trifluoromethoxy, N or NR′₂: dimethylamino, diethylamino, methyl ethylamino, pyrrolidyl, etc. Among these, dimethylamino and diethylamino are the most preferred from the perspective of hydrolysis reactivity when used as resist materials, and tert-butoxy, tert-amyloxy, and 2-methyl-pentyloxy are the most preferred in terms of balancing stability and reactivity.

Additionally, the organic groups included in R and substituent X in the molecule may be bonded to each other to form a cyclic structure. In that case, compounds with the following structures can be mentioned as examples.

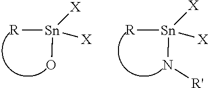

### [Structure of Tin Compound]

For tin compound A1, the structure and properties are not particularly limited as long as they fall within the above range, but in the case of using it as an EUV resist material, there are cases where it is preferable to have the following properties.

### (Boiling Point)

It is preferable for the boiling point of tin compound A1 to be 300° C. or less at 1 torr, more preferably 250° C. or less, further preferably 200° C. or less, and particularly preferably 150° C. or less. The lower limit of the boiling point at 1 torr is usually 0° C. or more, preferably 10° C. or more, and more preferably 20° C. or more. Having a boiling point below the aforementioned upper limit makes it possible to perform distillation at low temperatures, which is preferable from the perspective of facilitating deposition when used as a resist material. Having a boiling point above the aforementioned lower limit tends to result in appropriate performance of high-temperature deposition or processes involving reactions when used as an EUV resist, and there is a tendency to suppress the volatilization and scattering of components and outgases due to the thermal stability of the formed film.

### (Molecular Weight)

It is preferable for the molecular weight of tin compound A1 to be 500 or less, more preferably 400 or less, and further preferably 350 or less. The lower limit is preferably 150 or more, more preferably 180 or more, and further preferably 200 or more. Having a molecular weight below the aforementioned upper limit tends to result in an appropriate boiling point, which in turn tends to result in appropriate performance of deposition and other processes when used as an EUV resist. Having a molecular weight above the aforementioned lower limit tends to result in appropriate performance of high-temperature deposition or processes involving reactions when used as an EUV resist, and there is a tendency to suppress the volatilization and scattering of components and outgases due to the thermal stability of the formed film.

### (Molecular Weight Difference Between Substituent R and Substituent X)

There are no particular restrictions on the molecular weight difference between substituent R and substituent X, but it is preferably 50 or less, more preferably 30 or less, further preferably 20 or less, particularly preferably 10 or less, and especially preferably 6 or less. The lower limit is usually 0 or more, and more preferably 1 or more. Making the molecular weight difference between R and X smaller tends to result in smaller mass differences between various outgases generated when used as a resist, making condition setting easier in the EUV process. Additionally, by changing the substituents to adjust the molecular weight difference, it is possible to control the EUV sensitivity and boiling point of the tin compound.

On the other hand, as described later, the smaller the molecular weight difference between R and X, the smaller the molecular weight difference between the target tin compound A1 and impurities, making purification more difficult.

### <Impurities>

### [Tin Compounds A2 and A3 as Impurities]

The tin compounds as impurities other than tin compound A1 are not particularly limited, but representative impurities include, for example, tin compounds A2 and A3 as shown below. Tin compounds A2 and A3 are compounds that are generated by the decomposition of tin compound A1 during the manufacturing reaction or heating, and they are particularly difficult to separate by distillation due to their similar structure and boiling point to tin compound A1.

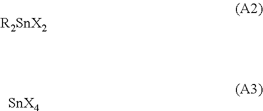

### (Decomposition of Tin Compound)

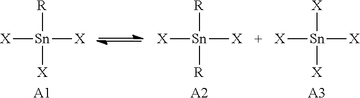

In the distillation of tin compounds, in addition to their physical properties such as boiling point, the side reactions and their decomposition rates during heating also become issues. For example, there may be disproportionation reactions, as shown in the above formula, and these reactions also occur during distillation in the purification process. Additionally, there may be cases when decomposition reactions occur due to light, or when decomposition reactions are accelerated by both light and heat. Furthermore, the presence of trace amounts of air, moisture, etc. may promote decomposition. In other words, even with distillation methods based on conventional technology, there may be cases when impurities generated by decomposition in the distillation pot or distillation column during distillation are mixed into the distillate, even if distillation separation is possible based on boiling point differences.

Additionally, as mentioned earlier, when the boiling points of tin compound A1 and tin compound A2 or A3 are close, distillation separation often becomes difficult. Note that the boiling point refers to the boiling point at the same pressure, especially at the pressure at which distillation is performed, not just at atmospheric pressure. When the boiling point difference is close, it means that the difference between the boiling points of tin compounds A1 and A2 is usually 50° C. or less, further 30° C. or less, further 10° C. or less, and particularly 5° C. or less.

Also, when the molecular weights of R and X are close, separation often becomes difficult due to the small difference in boiling points or the large intermolecular interactions. When the difference in molecular weight between R and X is close, it means that the difference is 30 or less, especially 20 or less, further 10 or less, and particularly 5 or less.

As an example, the molecular weight difference between iPrSn(NMe₂)₃ (A1-1) and iPr₂Sn(NMe₂)₂ (A2-1) is small (294 g/mol and 293 g/mol, respectively). The difference is only 1 g/mol, and additionally, the polarity of isopropyl and dimethylamino groups is very similar, so the boiling point difference between tin compounds A1-1 and A2-1 is extremely small. When the boiling points of these compounds were measured, the boiling point difference between the two compounds was within 2° C. in the pressure range of 0.7 to 10 torr. In other words, to obtain high-purity tin compound (A1-1), a distillation with high separation capability is required.

Additionally, depending on the method used, impurities such as tin compounds with more alkyl groups, such as R₃SnX and R₄Sn, may also be mixed in, and separation may be required during distillation.

### [Tin Compound A4 as Impurity]

Additionally, when tin compound A1 is RSn(NMe₂)₃ the following tin compound A4 may be contained as an impurity in the crude tin compound.

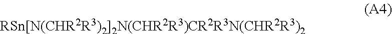

In general formula (A4), R is an organic group with 1 to 30 carbon atoms, which may be partially substituted with halogen, oxygen, or nitrogen atoms. R² and R³ are independently hydrogen atoms or organic groups with 1 to 10 carbon atoms, which may be partially substituted with halogen, oxygen, or nitrogen atoms. R² and R³ may be bonded to form a cyclic structure.

Tin compound A4 is generated by the decomposition of tin compound A1, and its generation may be accelerated by heat, light, or a combination of these factors. For example, when tin compound A1 is iPrSn(NMe₂)₃ (A1-2), impurities of tin compound A4 may include the compound represented by formula (A4-1), iPrSn(NMe₂)₂ (N(Me)CH₂NMe₂) (A4-1). This compound has the following ¹¹⁹Sn-NMR spectrum and ¹H-NMR chemical shift, and can be identified and quantified.

¹¹⁹Sn-NMR (223.8 MHz, C₆D₆): δ−82 ppm.

¹H-NMR (600 MHz, C₆D₆): δ 3.37 (s, 2H, CH₂), 2.89 (s, 3H, Sn—NMe), 2.86 (s, 12H, Sn—(NMe₂)₂), 2.15 (s, 6H, NMe₂), 1.68 (m, 1H, iPr), 1.33 (s, 6H, iPr).

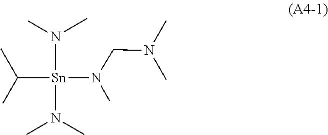 [SMILES: C[CH](C)[Sn]([N](C)C)([N](C)C)[N](C)CN(C)C]

Additionally, there may be cases when A1 contains divalent tin compound SnX₂ (A8). When tin compound A1 is RSn(NR₂)₃, the following compound (8) can be mentioned.

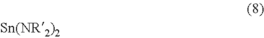

The content of SnX₂ (A8) is preferably 1.0 mol % or less in terms of tin atoms relative to the crude tin compound from the perspective of high-purity resist material, more preferably 0.5 mol % or less, further preferably 0.1 mol % or less, and particularly preferably 0.01 mol % or less.

Among the compounds represented by the above general formulas (A2), (A3), and (A4), the compounds that do not substantially contain halogen atoms in the molecule are represented by the following general formulas (B2), (B3), and (B4), respectively. Additionally, the “R”, “R”, “X”, “R²”, and “R³” in the general formulas (A2), (A3), (A4), (A4-1), and (A8) can be read as “R^{B}”, “R′^{B}”, “X^{B}”, “R 2B” and “R³B” in the general formulas (B2), (B3), (B4), (B4-1), and (B8), respectively.

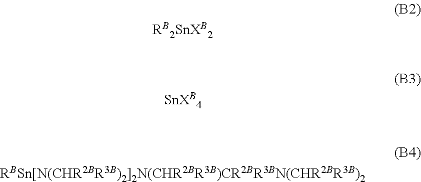

### <Crude Tin Compound>

The crude tin compound, which is the raw material before purification by the present purification method (before use in distillation), contains tin compound A1 as the main component. The content of tin compound A1 (A1 purity) in the crude tin compound is preferably 70 mol % or more, more preferably 80 mol % or more, further preferably 85 mol % or more, and particularly preferably 90 mol % or more, but usually less than 95 mol %.

On the other hand, the components other than tin compound A1 in the crude tin compound are impurities, and for example, metal impurities such as tin compounds A2, A3, and A4 can be mentioned. The content of impurities is the amount obtained by subtracting the amount of tin compound A1 from the crude tin compound. Among the impurities, the content of impurities with similar molecular weight and boiling point (boiling point difference of 10° C. or less) is preferably 10 mol % or less, more preferably 5 mol % or less, and further preferably 3 mol % or less. The lower the content, the more preferable, but usually 1 mol % or more is contained. The aforementioned metal impurities preferably have a low content because they may accelerate the decomposition reaction of tin compound A1. If the quality of compound A1 before distillation in the present purification method is not sufficient, performing pretreatment (such as filtration, purification by columns, addition of adsorbents or reaction agents), or conducting simple distillation different from the present purification method beforehand may lead to improved quality during distillation in the present purification method.

### [Method for Manufacturing Crude Tin Compound]

The method for manufacturing the crude tin compound is not particularly limited, and it can be manufactured by known methods. Specifically, as a method for manufacturing tin compounds containing tin compound A1 as the main component with the aim of obtaining tin compound A1, the following methods can be mentioned as examples.

Note that tin compound A1 and tin compound B1 are essentially the same except for the difference in the amount of halogen atoms in the molecule, so the following “R”, “R”, “X”, and “Y” in the manufacturing method can be read as “R^{B}”, “R′^{B}”, “X^{B}”, and “Y^{B}” in the general formula (B1), respectively.

### (Manufacturing Method 1)

As an example, monomethyl tin compound RSnY₃, which is the raw material, is synthesized with reaction agent MX containing X.

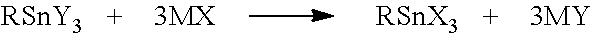

(Note that X and Y are different in the above reaction formula.)

Manufacturing Method 1 is preferable because it is possible to increase the purity of tin compound RSnY₃, which is the raw material, by purification, and high-purity RSnX₃ (A1) can be obtained. Additionally, it has the potential to reduce impurities such as tin compounds A2, A3, and A4, which are difficult to separate during distillation, as it uses tin compounds with pre-introduced substituent R as the raw material.

The substituent Y in the reaction formula is not limited in structure as long as it is a substituent that reacts with and is replaced by reaction agent MX, but some preferred specific examples are substituents selected from halogen atoms, OR′ NR′, and NR′₂, and halogen atoms are preferred due to their high reactivity. Among them, chlorine atoms are preferred because they have a good balance of stability and reactivity, making it easier to prepare high-purity tin compound A1.

M in the reaction formula represents a metal atom of Group 1, 2, 12, or 13, or a hydrogen atom. In some cases, MX is represented when M is a Group 1 or hydrogen atom, MX₂ is represented when M is a Group 2 or 12 atom, and MX₃ is represented when M is a Group 13 atom, and the multiple X in the molecule may be different. Additionally, X is as described in the aforementioned section. Specifically, when X is OR′, examples include HOR′, LiOR′, NaOR′, KOR′, MgOR′₂, and ZnOR′₂, and from the perspective of reactivity, LiOR′, NaOR′, and KOR′ are preferred, and from the perspective of metal contamination, HOR′ is preferred. When X is NR′₂, examples include HNR′₂. LiNR′₂, NaNR′₂, KNR′₂, Mg(NR′₂)₂, and Zn(NR′₂)₂, and from the perspective of reactivity, LiNR′₂, NaNR′₂, and KNR′₂ are preferred, and from the perspective of stability, Mg(NR′₂)₂ and Zn(NR′₂)₂ are preferred, and from the perspective of metal contamination, HOR′ is preferred. From the perspective of the ease of preparing high-purity reagents, LiNR′₂ is most preferred.

The purity of tin compound RSnY₃, which is the raw material for tin compound A1, is preferably higher, and it is usually 95 mol % or more in terms of tin atoms, preferably 97 mol % or more, more preferably 99 mol % or more, further preferably 99.5 mol % or more, and further preferably 99.9 mol % or more. The upper limit is 100 mol %. On the other hand, impurity tin compounds may contribute to stabilization, such as preventing crystallization of the target product, and in some cases, it may be preferable to include 0.1 mol % or more, 0.2 mol % or more, or 0.3 mol % or more of impurities in the raw material.

Additionally, when the raw material contains impurities such as R₂SnY₂, R₃SnY, R₄Sn, and SnY₄, their proportions are preferably 3 mol % or less, more preferably 2 mol % or less, particularly preferably 1 mol % or less, and further preferably 0.1 mol % or less in terms of tin atoms. On the other hand, in some cases, it may be preferable to include 0.01 mol % or more or 0.1 mol % or more of these impurities, as they may contribute to stabilization, such as preventing crystallization of the target product.

### (Manufacturing Method 2)

As an example, tin compound SnX₄, which is the raw material, is synthesized with reaction agent RMX or RMZ containing R.

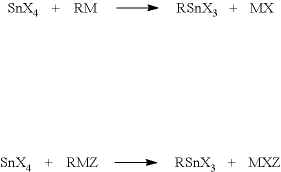

In the above reaction formula, M represents a metal atom of Group 1, 2, 12, or 13, or a hydrogen atom. In some cases, RM is represented when M is a Group 1 or hydrogen atom, RMZ is represented when M is a Group 2 or 12 atom, and RMZ₂ is represented when M is a Group 13 atom, and the multiple X in the molecule may be different. Z represents a halogen atom or R. The multiple Z in the molecule may be different. Additionally, X is as described in the aforementioned section. Specifically, when X is OR′, examples include ROH, RLi, RNa, RK, RMgZ, RZnZ, and R²Zn, and from the perspective of reactivity, RLi is preferred. From the perspective of reaction selectivity for monoalkylation and the low basicity that prevents decomposition of the target product, RMgZ and RZnZ are preferred, and between them, RMgZ is particularly preferred. From the perspective of metal contamination, ROH is preferred.

### (Manufacturing Method 3)

As an example, this method consists of step a, in which monomethyl tin compound SnX₂, which is the raw material, is reacted with reaction agent MX containing M to produce MSnX₃, and step B, in which the obtained MSnX₃ is reacted with MZ.

In the reaction formula, M represents a metal atom of Group 1, 2, 12, or 13. In some cases, MX is represented when M is a Group 1 atom, MX₂ is represented when M is a Group 2 or 12 atom, and MX₃ is represented when M is a Group 13 atom, and the multiple X in the molecule may be different. Additionally, X is as described in the aforementioned section. Specifically, when X is OR′, examples include LiOR′, NaOR′, KOR′, MgOR′₂, and ZnOR′₂, and from the perspective of reactivity, LiOR′, NaOR′, and KOR′ are preferred. When X is NR′₂, examples include LiNR′₂, NaNR′₂, KNR′₂, Mg(NR′₂)₂, and Zn(NR′₂)₂, and from the perspective of reactivity, LiNR′₂, NaNR′₂, and KNR′₂ are preferred. Among them, LiNR′₂ is most preferred from the perspective of the ease of preparing high-purity reagents.

### <Distillation>

The distillation of the crude tin compound in the present purification method is a distillation to prevent the decomposition of tin compound A1 and remove impurities with boiling points close to that of tin compound A1, in order to obtain high-purity tin compound A1. To achieve this, it is necessary to optimize the equipment and conditions related to distillation, and the following items should be specifically considered.

### [Distillation Equipment and Conditions]

Quality of crude product (crude tin compound) before distillation: reaction conditions, post-treatment conditions, purity of crude product (crude tin compound), metal content, solvent content® Distillation pot (material, shape, capacity, heating surface area, stirring blade, stirring speed)
Distillation column (height, thickness, number of theoretical plates, shape, material, separation performance, surface area, length, residence time)
Distillation conditions: reflux ratio (cooling temperature, extraction time), extraction speed, heating amount, temperature (external temperature, internal temperature), time (heating time, distillation time), degree of vacuum (degree of vacuum, pressure loss)
Other equipment, conditions: distillation method of distillate into fractions, extraction method and position of distillate, light-shielding conditions, inert atmosphere, filling method, number of distillations, continuous distillation or batch distillation

### [Distillation Equipment]

The distillation equipment used in the present purification method is not particularly limited as long as it is capable of purifying tin compounds by distillation, but it is preferable to use equipment with heating equipment (distillation pot, etc.), distillation purification equipment (distillation column, cooling reflux device, fractionation equipment, etc.), and vacuum equipment (vacuum pump, etc.). Additionally, it is sometimes preferable to divide the distillate into multiple fractions. By dividing into fractions, it is possible to analyze the purity in each fraction, and in some cases, it is possible to obtain tin compounds with higher purity in a specific fraction.

### [Distillation Pot]

The material (inside of the pot, stirring blade) is not particularly limited, but Teflon, glass, SUS, etc. are preferably mentioned. Among them, glass is preferred from the perspective of preventing metal contamination, and SUS is preferred from the perspective of strength and thermal conductivity.

The shape and capacity can be set arbitrarily according to the required distillation amount, but for efficient distillation, 100 mL or more is preferable, and 1 L or more is further preferable. Depending on these, the surface area of the heat transfer part may change.

The shape of the stirring blade includes, for example, paddle, anchor, twin star, ribbon, three-blade reverse, log bone, full zone, max blend, etc. Among them, paddle, twin star, and three-blade reverse are preferred because they can provide sufficient stirring strength even with a small or large amount of liquid. Additionally, installing multiple stirring blades can improve the stirring capacity. When using a stirring blade, it is preferable to use a sufficiently large one relative to the reaction liquid amount.

### [Stirring Speed (Rotation Speed)]

The preferred stirring speed varies depending on the size and shape of the stirring blade, but it is preferable to have a rotation speed of 50 rpm or more, more preferably 100 rpm or more, and further preferably 150 rpm or more. Higher stirring speed allows for faster distillation as the liquid can be dispersed more thinly within the distillation pot. Additionally, the increased diffusion in the heated solution can reduce temperature variations during distillation, preventing decomposition at high temperatures near the jacket temperature. In other words, by increasing the stirring, there is a tendency to be able to achieve shorter distillation times or lower temperature distillation, making it easier to obtain high-purity tin compound A1.

### [Distillation Column]

The number of theoretical plates is not limited as long as it is capable of separating impurities, but it is preferably 5 or more, more preferably 10 or more, especially when the boiling points of impurities are close to that of tin compound A1 and separation is difficult. On the other hand, if the number of theoretical plates is too large, there is a tendency for the distillation time to be prolonged, promoting decomposition and reducing the extraction speed, leading to decreased productivity. Therefore, it is preferably 100 or less, more preferably 70 or less, and further preferably 50 or less. Additionally, the larger the number of theoretical plates, the larger the equipment becomes, leading to an increase in equipment costs. From the perspective of equipment costs, it is preferable to have a smaller number of theoretical plates within the range that satisfies the required distillation capacity.

As a fifth embodiment or aspect of the disclosure, it is preferable that the distillation step employs a packed distillation tower equipped with insulation equipment and/or heating equipment. The packing material and structure inside the distillation column are not particularly limited, but a structure with regular packing material is preferred due to its high number of theoretical plates and low pressure loss performance. The material of the packing material is preferably glass or SUS. Some preferred specific examples include Sulzer Packing (Gauze packing, etc.), Sulzer laboratory packing, Mellapak™, Flexipac®, Goodloe® Packing, Rombopak, etc., and among them, Sulzer Packing (Gauze packing, etc.) and Sulzer laboratory packing are preferred due to their high number of theoretical plates and low pressure loss performance.

The HETP (m/plate) of the packing material in the distillation conditions is preferably 1.0 or less, more preferably 0.8 or less, further preferably 0.5 or less, and particularly preferably 0.3 or less. Lower HETP can reduce pressure loss, allowing for shorter distillation times or lower temperature distillation, making it easier to obtain high-purity tin compound A1.

### <Heating and Insulation Equipment for Distillation Column>

In some cases, heating and insulation equipment is used in conjunction with the distillation column for temperature control inside the distillation column, improving distillation productivity, and increasing the purity of tin compound A1. A jacket is a temperature control equipment that covers the outside of a heating vessel (distillation pot). For insulation equipment, for example, vacuum insulation jackets, insulation materials, and insulating materials may be used, but vacuum jackets are preferred from the perspective of insulation effect. For heating equipment, for example, internal heaters (internal coils, heat exchangers, etc.), external heaters (sheet heaters, tape heaters, oil baths, etc.), heat transfer jackets, hot air heating equipment (dryers, etc.) can be mentioned, but external heaters are preferred from the perspective of local temperature control. Additionally, by combining insulation equipment and heating equipment, more effective temperature control may be achieved in some cases. In particular, for the purification of compounds such as tin compound A1 of the present invention, which are prone to decomposition during distillation, it is preferable as it can shorten the startup time of distillation (operation to stabilize the distillation column by filling it with liquid) and improve the extraction speed, as described later. As a result, there is a tendency to make it easier to obtain high-purity tin compound A1.

It is further preferable to use a distillation column with regular packing material in conjunction with heating and/or insulation equipment, as the synergistic effect may allow for even shorter distillation times or lower temperature distillation, making it easier to obtain high-purity tin compound A1. For the regular packing material and its HETP, the aforementioned ones are preferably mentioned. Additionally, it is preferable for the distillation column to have both insulation equipment and heating equipment.

### [Distillation Conditions]

The following describes the conditions related to distillation for each item. In some cases, the distillation conditions are combined with each item and its preferred conditions to obtain higher purity tin compound A1. Additionally, in some cases, combining specific distillation equipment and distillation conditions may result in synergistic effects, leading to higher purification efficiency and productivity.

### (Reflux Ratio)

Although it is possible to perform the present distillation without controlling the reflux ratio, appropriate control may improve separation efficiency and shorten distillation time. The method for controlling the reflux ratio is not particularly limited, but it may be implemented by time control of the opening/closing of the outlet or flow rate control of the reflux/extraction of the distillate. The reflux ratio of 10 represents a control of 1:10 for the extraction amount and reflux amount. The lower limit of the reflux ratio is preferably 0.1 or more, more preferably 1 or more, and further preferably 3 or more. If the reflux ratio is below the lower limit, there is a tendency for insufficient distillation efficiency, with impurities with close boiling points mixing into the distillate, resulting in no purification effect. The upper limit of the reflux ratio is preferably 200 or less, more preferably 150 or less, and further preferably 100 or less. If the reflux ratio is above the upper limit, there is a tendency for the distillation time to become too long, accelerating the decomposition of tin compounds, and reducing the extraction speed, leading to decreased productivity.

### (Distillation Time)

The distillation time is not limited by the scale or equipment of distillation, but it is preferable to be shorter within a range that ensures appropriate productivity, and it is usually 200 hours (hereinafter “h”) or less, preferably 100 h or less, and more preferably 50 h or less. Additionally, the lower limit of the distillation time is preferably 1 h or more, and more preferably 10 h or more. The distillation time refers to the time during which distillation is performed under the desired conditions. Additionally, the heating time is also preferably shorter within a range that ensures appropriate productivity, and it is usually 200 h or less, preferably 100 h or less, and more preferably 50 h or less. (Distillation Temperature)

The distillation temperature in the present purification method refers to the internal temperature, which is the temperature of the solution inside the distillation pot during distillation. The distillation temperature depends on the boiling point of the target product and other distillation conditions, but the lower limit is preferably 20° C. or more, more preferably 30° C. or more, and further preferably 50° C. or more. The upper limit is preferably 200° C. or less, more preferably 180° C. or less, and further preferably 150° C. or less. If the distillation temperature is too high, there is a tendency for the decomposition of tin compounds to be accelerated, or the extraction amount to be too large, leading to flooding inside the distillation column and insufficient separation. If the distillation temperature is too low, there is a tendency for the extraction amount to be too small, leading to prolonged distillation time, accelerated decomposition, and decreased separation performance of the distillation column.

Note that, as described above, the distillation temperature refers to the internal temperature during distillation, but in some cases, the decomposition rate of tin compound A1 may also be influenced by the temperature at a different location from the distillation temperature (internal temperature), such as the jacket temperature (heat transfer medium temperature) or the top temperature of the distillation column.

The difference between the jacket temperature and the distillation temperature (internal temperature) is preferably 3-40° C. from the perspective of separation performance, more preferably 5-30° C., and further preferably 10-20° C.

### (Cooling Condenser Temperature)

The cooling temperature of the cooling condenser at the top of the distillation column is preferably below the boiling point of the target tin compound A1, and it is preferable to use a cooling condenser with a temperature 10-70° C. lower than the boiling point of tin compound A1.

The temperature difference between the condenser cooling temperature and the boiling point of tin compound A1 is preferably 50° C. or less, more preferably 30° C. or less, and further preferably 10° C. or less. If the cooling is too strong, there is a tendency for tin compounds to precipitate inside the distillation column, or for the cooling of the distillation pot to progress, requiring a higher jacket temperature.

### (Pressure During Distillation (Degree of Vacuum))

The distillation in the present purification method is basically performed under reduced pressure conditions because the boiling point of tin compound A1 is high under normal pressure. At that time, it is preferable to have a lower pressure so that distillation can be performed at a lower temperature to prevent the decomposition of tin compound A1. Specifically, it is preferably 100 torr or less, more preferably 50 torr or less, further preferably 20 torr or less, particularly preferably 15 torr or less, especially preferably 10 torr or less, and particularly preferably 5 torr or less. On the other hand, for conditions requiring particularly high separation or under scaled-up conditions, it is preferably 0.01 torr or more, more preferably 0.1 torr or more, and further preferably 1 torr or more due to the performance of the vacuum pump and pressure loss of the distillation column.

### (Total Reflux Conditions)

The term “total reflux” refers to the state where all cock (valve) s at all distillate outlets are closed and all distillate is refluxed, for example, before starting the extraction, to stabilize various distillation conditions under total reflux conditions. The time under total reflux conditions is preferably 20 h or less, more preferably 10 h or less, further preferably 8 h or less, and particularly preferably 5 h or less. If the time under total reflux conditions is too long, there is a tendency for decomposition to be accelerated. On the other hand, as the scale of distillation increases, the time required to fill the distillation column with liquid and reach appropriate distillation conditions becomes longer, and if it is too short, there is a possibility of decreased separation efficiency of distillation. In that case, the lower limit is preferably 1 h or more, and more preferably 3 h or more.

### (Extraction Speed)

The extraction speed in the present purification method is based on the following extraction rate:

$$Extraction rate ( \% ) = Extraction mass ( g ) / Charged mass ( g ) \times 100$$

$$Extraction speed ( \% / h ) = Extraction rate ( \% ) / Extraction time ( h )$$

The extraction time refers to the time during which extraction is performed, and it does not include the time when the extraction amount is zero or the retention time under total reflux conditions. Additionally, the extraction speed may also be calculated from the distillation time and extraction amount for all distillate, but it is also possible to calculate the extraction speed for each fraction from the extraction time and extraction amount for each fraction.

The preferred extraction speed (%/h) is preferably 1 or more, more preferably 2 or more, further preferably 3 or more, particularly preferably 4 or more, and especially preferably 5 or more. If the extraction speed is too low, there is a tendency for the distillation time to become longer, leading to decomposition during distillation and a decrease in the purity of the obtained distillate. Additionally, from the perspective of distillation productivity, it is preferably higher. On the other hand, if the extraction speed is too high, there is a tendency for the solution to accumulate too much inside the distillation column, leading to flooding and insufficient separation.

### (Form of Distillation)

The form of distillation or device configuration in the present purification method is not particularly limited. The distillation form may be either batch distillation or continuous distillation, but batch distillation is preferable from the perspective of being able to recover high-purity distillate, and continuous distillation is also preferable in some cases from the perspective of yield. Additionally, in some cases, multiple distillations are performed or multiple distillation equipment are combined to perform more efficient purification. There are also cases when the feed position of the distillation liquid or the extraction position of the distillate is changed.

In the distillation of the present purification method, it is preferable to satisfy at least one of the conditions of the following first to fifth embodiments or aspects of the disclosure from the perspective of the effects of the present invention. It is noted that the following five “embodiments” refer to five general aspects of the disclosure; the terms “embodiment” and “aspect of the disclosure” may be used interchangeably. Additionally, when performing multiple distillation steps, it is preferable for at least one of the distillation steps to satisfy at least one of the conditions of the following first to fifth embodiments. Furthermore, when performing distillation by simultaneously connecting multiple distillation columns, it is preferable for at least one of the distillation columns to satisfy at least one of the conditions of the following first to fifth embodiments. The first to fifth embodiments can be implemented by combining any number of embodiments. That is, the specific method steps described herein may be combined in any way, and all of such combinations are within the scope of the disclosure. In that case, the effect of the invention can be obtained more efficiently.

### First Embodiment (Aspect of the Disclosure): Combination of Theoretical Plate Number and Reflux Ratio

As described above, the theoretical plate number and reflux ratio each affect the distillation separation efficiency, and by combining specific values within a certain range for tin compound A1 distillation, there are cases when distillation separation can be performed more efficiently, allowing for shorter distillation times and obtaining high-purity distillate with simpler equipment. In particular, there are cases when it is preferable to use a distillation column with a high theoretical plate number and combine it with a low reflux ratio to perform distillation, as it can achieve both high separation efficiency distillation conditions and short distillation time without decomposition.

The combination of distillation plates and reflux ratio is preferably 10 plates or more and a reflux ratio of 30 or less, more preferably 15 plates or more and a reflux ratio of 25 or less, further preferably 18 plates or more and a reflux ratio of 20 or less, particularly preferably 20 plates or more and a reflux ratio of 18 or less, especially preferably 23 plates or more and a reflux ratio of 15 or less, and most preferably 25 plates or more and a reflux ratio of 13 or less.

In the preferred combination, the upper limit of the number of plates is not particularly restricted, but from the perspective of shortening the distillation time of the distillation column and reducing equipment costs, it is preferably 100 or less, more preferably 50 or less, and further preferably 30 or less.

In the preferred combination, the lower limit of the reflux ratio is not particularly restricted, but from the perspective of stably obtaining high-purity tin compounds, it is preferably 0.01 or more, more preferably 0.1 or more, and further preferably 0.5 or more.

In the distillation of the present embodiment, it is preferable for the extraction time to be 1-20 hours from the perspective of suppressing the increase in impurities due to the decomposition of tin compound A1, more preferably 2-15 hours, and further preferably 3-10 hours.

### Second Embodiment (Aspect of the Disclosure): Distillation Using Multiple Distillation Conditions

In the distillation of this embodiment, it is preferable to perform the process through multiple plates with different distillation conditions. For example, it is desirable to include specific operations such as the following processes 1 and 2.

### (Process 1)

The initial distillate, which corresponds to 0.1-50% by mass of the total distillate, is distilled under reflux ratio conditions of less than 1.

### (Process 2)

The remaining distillate, excluding the initial distillate from process 1, is distilled under reflux ratio conditions of 1 or more.

In process 1, the feature is to extract an initial specific amount of distillate under low reflux ratio conditions. It is preferable that the distillate extracted in process 1 is less than or equal to 50% by mass as an upper limit, more preferably less than or equal to 45% by mass, further preferably less than or equal to 43% by mass, and particularly preferably less than or equal to 40% by mass. As a lower limit, it is preferably greater than or equal to 0.1% by mass, more preferably greater than or equal to 1% by mass, further preferably greater than or equal to 3% by mass, and particularly preferably greater than or equal to 10% by mass.

As for the reflux ratio in process 1, it is preferably less than or equal to 1, more preferably less than 1, further preferably less than or equal to 0.5, and further preferably less than or equal to 0.2.

By performing process 1, it is possible to efficiently remove gas components accumulated in the distillation column, and it is possible to suppress the decomposition of tin compound A1 in subsequent processes 2 and beyond. The larger the extraction amount in process 1, the greater the effect, but there is a possibility that the high-purity distillate that can be obtained in processes 2 and beyond will decrease. Also, if the reflux ratio is too large, the time required for distillation increases, and there is a tendency for the efficient removal of accumulated gas components to be hindered or the decomposition of tin compounds to be accelerated. As for the time of process 1, it is preferably less than or equal to 10h, more preferably less than or equal to 8h, further preferably less than or equal to 6h, and particularly preferably less than or equal to 4h. As a lower limit, it is preferably greater than or equal to 0.05h, and more preferably greater than or equal to 0.1h.

In process 2, the feature is to extract the distillate after process 1 under higher reflux ratio conditions than process 1. Although the reflux ratio is not particularly specified as long as the impurity tin compound may be removed and high-purity tin compound A1 may be obtained, it is preferably greater than or equal to 1, more preferably greater than 1, further preferably greater than or equal to 3, further preferably greater than or equal to 5, particularly preferably greater than or equal to 10, and especially preferably greater than or equal to 20. As for the upper limit of the reflux ratio, it is preferably less than or equal to 200, more preferably less than or equal to 150, and further preferably less than or equal to 100. If the reflux ratio is too small, there is a tendency to be unable to separate impurities with small boiling point differences. If the reflux ratio is too large, there is a tendency for the time required for distillation to increase and the decomposition of tin compounds to be accelerated.

It is preferable for the distillation rate in process I to be higher than that in process 2. It is important to efficiently remove the accumulated gas and the like in the distillation column by setting the distillation rate in process 1 to be high. On the other hand, in process 2, when the influence of accumulated gas and the like is small, it is possible to perform more precise separation by setting the distillation rate to be lower than that in process 1, which may result in higher separation efficiency and the acquisition of higher-purity tin compound A1. As for the specific ratio of distillation rates (distillation rate in process 1/distillation rate in process 2), it is preferable to be greater than or equal to 1.5, more preferably greater than or equal to 2.0, and further preferably greater than or equal to 3.0.

### Third Embodiment (Aspect of the Disclosure): Heat Transfer Area Per Mass of Tin Compound

In the distillation of this embodiment, it is preferable for the heat transfer area of the heating vessel in the distillation to be less than or equal to 1.0 cm²/g per mass of the tin compound.

Here, the heat transfer area (cm²) refers not to the heat transfer area of the distillation pot (heating vessel) itself, but to the area where the crude tin compound (solution before distillation) in the distillation pot is in contact with the heating jacket, as defined below. For example, in the case of heating a flask (heating vessel) filled with crude tin compound in an oil bath, the heat transfer area (cm²) is the area where the liquid of the filled crude tin compound comes into contact with the heat transfer medium oil through the wall surface of the flask. There is no particular restriction on the method for measuring the heat transfer area, but for example, the surface area of the heating vessel such as a distillation kiln may be calculated from the diameter of the container, assuming that the shape of the container is approximately spherical or cylindrical.

The value obtained by dividing the above heat transfer area (cm²) by the mass (g) of the tin compound is called the heat transfer area per mass of the tin compound (cm²/g). As for the heat transfer area per mass of the tin compound (cm²/g), it is preferable to be less than or equal to 1.0 cm²/g as described above, more preferably less than or equal to 0.8 cm²/g, further preferably less than or equal to 0.5 cm²/g, and further preferably less than or equal to 0.1 cm²/g. If the heat transfer area per mass of the tin compound (cm²/g) is within this upper limit, the proportion of jacket temperature higher than the internal temperature that is transmitted during distillation becomes smaller, and decomposition can be reduced. In some cases, it is also possible to suppress the decomposition reaction that uses the surface of the distillation pot, such as glass or SUS, as a catalyst. As for the lower limit, there is no particular limitation within the range when heating is possible and distillation may be performed, but in some cases, long-term distillation may be required due to poor heat transfer efficiency. Therefore, it is preferable to be greater than or equal to 0.0001 cm²/g, more preferably greater than or equal to 0.001 cm²/g, and further preferably greater than or equal to 0.01 cm²/g. By setting the heat transfer area per mass of the tin compound within the above range, decomposition may be reduced, and it becomes easier to set the number of theoretical plates and the reflux ratio in the distillation within an appropriate range. For example, it becomes possible to obtain a distillate of a desirable purity without raising the number of theoretical plates beyond necessity and while maintaining the reflux ratio within a range that does not reduce productivity, and thus, it becomes possible to achieve both high purity and production cost.

### Fourth Embodiment (Aspect of the Disclosure): Intermediate Extraction in Distillation Column

In the distillation of this embodiment, it is preferable to obtain a tin compound with a purity of 95 mol % or higher by extracting the distillate from a distillate outlet located below the highest distillate outlet in the vertical direction of the distillation column.

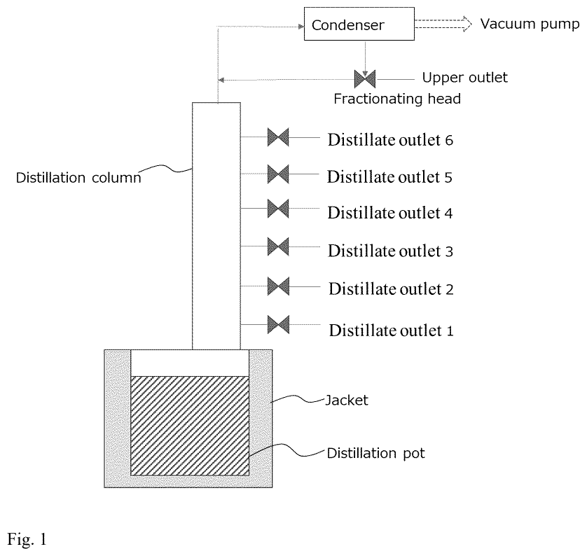

Here, the distillation column has at least one distillate outlet for extracting the distillate, but it may also have multiple distillate outlets. It may also have an opening for joining with a cooling condenser or the like. As for the positional relationship between the distillation column and the distillate outlet, the highest distillate outlet in the vertical direction of the distillation column, and the distillate outlet located below the highest distillate outlet in the vertical direction of the distillation column are expressed. For example, as a preferable utilization method of the distillate outlet, in the case of purifying the desired tin compound A1 (medium boiling point) by distillation from a mixture (crude tin compound) containing the desired tin compound A1, high boiling point impurities, and low boiling point impurities, there is a case where a highly efficient and high-purity tin compound A1 can be obtained by extracting from the distillate outlet located below the highest distillate outlet in the vertical direction of the distillation column, in a single distillation process and a single distillation column. Also, by closing the highest distillate outlet in the vertical direction of the distillation column when extracting from the distillate outlet, it is possible to efficiently perform extraction from the distillate outlet located below the highest distillate outlet in the vertical direction of the distillation column. FIG. 1 is a diagram of a distillation apparatus according to one aspect of the disclosure. As shown in FIG. 1, a distillation column with a jacket is connected to a distillation column having multiple distillate outlets at different vertical positions of the distillation column; six distillate outlets numbered 1 to 6 are shown in FIG. 1 The distillate outlet at the top of the vertical direction of the distillation column is connected to a condenser, and the condenser is connected to a vacuum pump and a fractionating head. The fractionating head is connected to the upper outlet of the distillation column and a pipe connects the distillation column and the condenser.

The fifth embodiment (aspect of the disclosure) is as described above.

### (Number of Theoretical Plates of the Distillate Outlet Located Below the Highest Distillate Outlet in the Vertical Direction of the Distillation Column)

When the distillation column has a number of theoretical plates, it is possible to calculate the number of theoretical plates of the distillate outlet according to its relative position within the distillation column. As for the appropriate number of theoretical plates at the distillate outlet located below the highest distillate outlet in the vertical direction of the distillation column, it is preferable to be greater than or equal to 1 plate as a lower limit, more preferably greater than or equal to 2 plates, further preferably greater than or equal to 3 plates, particularly preferably greater than or equal to 5 plates, and especially preferably greater than or equal to 10 plates. As for the upper limit, it is preferable to be less than or equal to 50 plates, more preferably less than or equal to 30 plates, and further preferably less than or equal to 20 plates.

### (Plate Ratio of the Intermediate Outlet)

The plate ratio of the distillate outlet located below the most upper distillate outlet in the vertical direction of the distillation column is defined as the ratio calculated by the following formula:

Plate ratio of the distillate outlet located below the highest distillate outlet in the vertical direction of the distillation column=Number of theoretical plates of the distillate outlet located below the highest distillate outlet in the vertical direction of the distillation column/Total number of plates of the distillation column (number of theoretical plates at the top of the distillation column)

It is preferable for the plate ratio of the distillate outlet located below the highest distillate outlet in the vertical direction of the distillation column to be 0.01-0.95. As for the appropriate lower limit of the plate ratio, it is preferable to be greater than or equal to 0.01, more preferably greater than or equal to 0.03, further preferably greater than or equal to 0.10, particularly preferably greater than or equal to 0.15, and especially preferably greater than or equal to 0.30. As for the upper limit, it is preferable to be less than or equal to 0.95, more preferably less than or equal to 0.80, further preferably less than or equal to 0.75, particularly preferably less than or equal to 0.60, and further preferably less than or equal to 0.50.

### [Other Distillation Conditions]

It is preferable to perform the distillation operation and the filling operation of the distillate under an inert atmosphere, as the crude tin compound supplied to this purification method is unstable against water and air. Specifically, it is preferable to recover the distillate into a container connected under an inert gas atmosphere when recovering the distillate. Alternatively, it is preferable to perform operations such as transferring to another container while maintaining the inert gas atmosphere. It is also preferable to perform sampling and analysis under similar inert gas atmosphere conditions.

Additionally, crude tin compounds may sometimes be unstable against light. Therefore, it is preferable to perform distillation under light-shielding conditions. For example, by using SUS-made devices or light-shielded glass devices (such as amber glass or glass devices surrounded by shielding) in all parts of the distillation pot, distillation column, and fractionation equipment, it is possible to achieve light resistance. Alternatively, light shielding may be achieved by wrapping the devices with light-shielding covers such as cloth, foil, or film, using light-shielding coatings, or performing distillation in a dark room, using any known method in the relevant technical field.

### <Purified Tin Compound>

Through this purification method, a purified tin compound can be obtained, and this purified tin compound is a tin compound with a purity of 95 mol % or higher, represented by the following general formula (A1) or (B1).

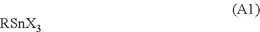

(In general formula (A1), R is an organic group with 1 to 30 carbon atoms, which may be partially substituted with halogen, oxygen, or nitrogen atoms. X is selected from OR′ or NR′₂. R′ is an organic group with 1 to 10 carbon atoms, which may be partially substituted with halogen, oxygen, or nitrogen atoms. When there are multiple R′ groups in the molecule, they may be different in structure, and they may also be bonded to form a cyclic structure.

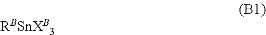

In general formula (B1), R^{B} is an organic group with 1 to 30 carbon atoms, which may be partially substituted with oxygen or nitrogen atoms. X^{B} is selected from OR′^{B} or NR′₂^{B}. R′^{B} is an organic group with 1 to 10 carbon atoms, which may be partially substituted with oxygen or nitrogen atoms. When there are multiple R′^{B} groups in the molecule, they may be the same or different in structure, and they may also be bonded to form a cyclic structure. R^{B} and X^{B} are substitution groups that are not substituted with halogen atoms.

### (Purity of Tin Compound A1 or B1)

The purity (content) of the purified tin compound A1 or B1 obtained by this purification method is 95 mol % or higher in terms of tin atoms. The higher the ratio of tin compound A1, the better the performance of the resist, so it is preferably 96 mol %, more preferably 97 mol %, further preferably 98 mol % or higher, particularly preferably 99 mol % or higher, especially preferably 99.2 mol % or higher, especially more preferably 99.5 mol % or higher, particularly preferably 99.8 mol % or higher, and most preferably 99.9 mol % or higher.

On the other hand, if the purity of the tin compound is too high, there is a possibility that decomposition or instability may occur during storage or use due to the deactivation reaction of the substituent R of the tin compound. In such cases, it is preferable to be less than or equal to 100.0 mol %, and more preferably less than or equal to 99.9 mol %.

Here, the mol % expressed in terms of tin atoms refers to the ratio of tin atoms in the target compound among all the tin-containing compounds (including unidentified compounds) with tin atoms. In practice, this is calculated by taking the total integral value of all observed peaks as the denominator and the integral value of the peak of the target compound as the numerator, using ¹¹⁹Sn-NMR.

Following this calculation method, only tin-containing compounds are considered in the calculation. For example, even if additives or solvents are added to the high-purity tin compound A1 (purified tin compound) obtained by manufacturing a crude tin compound and then purifying it using the present purification method, according to each application, the tin compound containing tin compound A1 and other impurities (tin compounds) is considered to be a tin compound obtained by the present purification method.

The analysis method for ¹¹⁹Sn-NMR can be performed without diluting the tin compound to improve sensitivity, and it may be obtained using multiple accumulation times (1000 times or more, preferably 10,000 times or more), sufficient relaxation time (1 second or more), and reverse gated decoupling conditions. As a result, by employing these methods, the detection limit for the impurities tin compounds A2, A3, and A4 may reach 0.01 mol %. Additionally, if the sensitivity of the measured peaks is still insufficient, it is possible to further enhance detection sensitivity by using high-sensitivity NMR (e.g., NMR at 600 MHz with a cryoprobe), allowing for detection at 0.001 mol % as well.

### (Impurity Content in Purified Tin Compound)

The impurities tin compounds A2, A3, and A4 in the obtained purified tin compound are as follows:

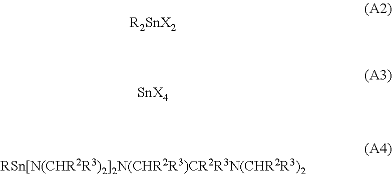

In the general formula (A4), R is an organic group with 1 to 30 carbon atoms, part of which may be substituted with halogen, oxygen atoms, or nitrogen atoms. R² and R³ are each independently a hydrogen atom or an organic group with 1 to 10 carbon atoms, and part of them may be substituted with halogen, oxygen atoms, or nitrogen atoms. R² and R³ may also be bonded to each other to form a cyclic structure.

When X in tin compound (A1) is a dialkylamino group (NR′₂) (where R′₂ is selected from a methyl group, a primary alkyl group, or a secondary alkyl group), the generation mechanism of tin compound (A4) is not clear, but it is estimated that the nitrogen radical (.NR′₂) formed by the departure of one of the three dialkylamino groups possessed by tin compound (A1) is inserted into the C—H bond next to the nitrogen atom of another nearby tin compound (A1). For example, tin compound RSn(NMe₂)₂ (N(Me)CH₂NMe₂) (A4-2) represents the case where R′is a methyl group when X in tin compound (A1) is a dialkylamino group (NR′₂). For example, when X in tin compound (A1) is a dialkylamino group (NR′₂) and R′is an ethyl group or other primary alkyl group (where R′ is represented as CH₂R¹), i.e., when tin compound (A1) is represented as RSnN(CH₂R¹)₃, tin compound (A4) is represented as RSn[N(CH₂R¹)₂]₂N(CH₂R¹)CHR¹N(CH₂R¹)₂ (A4-3).

Furthermore, when X in tin compound (A1) is a dialkylamino group (NR′₂) and R′is an isopropyl group or other secondary alkyl group (where R′is represented as CHR¹¹R¹¹¹), i.e., when tin compound (A1) is represented as RSn[N(CH¹¹R¹¹¹)₂]₃, tin compound (A4) is represented as RSn[N(CHR¹¹R¹¹¹)₂]₂N(CHR¹¹R¹¹¹)CR¹¹R¹¹¹N(CHR¹¹R¹¹¹)₂ (A4-4). R¹, R¹¹, and R¹¹¹ are each independently an organic group with 1 to 10 carbon atoms, and part of them may be substituted with halogen atoms, oxygen atoms, or nitrogen atoms.

In tin compounds that do not essentially contain halogen atoms in the molecule, the impurities tin compounds B2, B3, and B4 in the obtained purified tin compound are as follows:

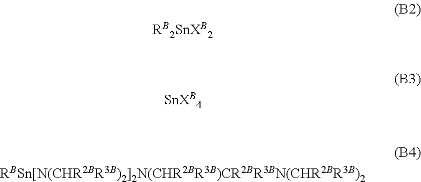

The content of impurity tin compound A2 or B2 in the purified tin compound is preferably 3 mol % or less, more preferably 2 mol % or less, further preferably 1 mol % or less, and even more preferably 0.5 mol % or less. If the content of tin compound A2 or B2 is too high, it may lead to a decrease in crosslinking and toughness when used as an EUV lithography resist. Additionally, tin compound A2 may cause outgassing when extreme ultraviolet light is irradiated on the photoresist, potentially resulting in the degradation of expensive multi-coated optical components in extreme situations.

The content of impurity tin compound A3 or B3 in the purified tin compound is preferably 3 mol % or less, more preferably 2 mol % or less, further preferably 1 mol % or less, and even more preferably 0.5 mol % or less. If the content of tin compound A3 or B3 is too high, it may result in excessive crosslinking when used as a resist material, leading to gelation or the formation of heterogeneous aggregates. Consequently, there is a tendency for adhesion to decrease and roughness to increase.

The content of impurity tin compound A4 or B4 in the purified tin compound is preferably 3 mol % or less, more preferably 2 mol % or less, further preferably 1 mol % or less, and even more preferably 0.5 mol % or less. If the content of tin compound A4 or B4 is too high, it may cause issues when used as a resist material. Due to differences in hydrolysis reactivity, the crystallinity may become poor, or heterogeneous aggregates may form. As a result, there is a tendency for adhesion to decrease and roughness to increase.

Other impurities may include polyalkyl compounds such as R₃SnX and R₄Sn, divalent tin compounds such as SnX₂, and tin oxide impurities with an RSnO structure formed by hydrolysis or the like. It is also preferable for these impurities to be 2 mol % or less, more preferably 1 mol % or less, further preferably 0.5 mol % or less, further preferably 0.3 mol % or less, further preferably 0.1 mol % or less, and further preferably 0.01 mol % or less in the purified tin compound.

### <Halogen Content>

In this embodiment, the halogen content in tin compound (B1) refers to the content of halogen atoms (F, Cl, Br, I) in the tin compound, which is expressed in units such as mass %, mass ppm, or mass ppb. In particular, for the most advanced fine semiconductor processes (e.g., EUV), there is a high possibility that trace halogen impurities in the semiconductor material may cause issues such as increased outgassing, pattern defects, short circuits, or corrosion of metal wiring, leading to potential performance degradation or reduced yield, and thus, more stringent management is required. Regarding the structure of compounds containing halogen atoms, various structures such as organic halogen compounds (compounds containing C-halogen bonds) and inorganic halogen compounds (compounds containing metal-halogen bonds) may be considered. However, the presence of tin compounds containing Sn-halogen bonds as impurities is a unique challenge for tin compound (B1), and it may be particularly problematic. Specifically, tin compounds containing Sn-halogen bonds often exhibit similar properties to tin compound (B1) in terms of stability, reactivity, volatility (boiling point), melting point, and solubility in organic solvents, making their separation from tin compound (B1) difficult. In other words, even with the halogen reduction techniques that have been implemented for similar semiconductor materials in the past (e.g., organic compounds or polymer-based resist materials), it may be challenging to remove these impurities.

Additionally, even when high purity and low metal content are achieved for tin compound (B1), there is a possibility that the halogen content cannot be reduced to the desired level due to the presence of trace amounts of tin compounds containing Sn-halogen bonds. The preferred range of halogen content in tin compound (B1) is as follows: for fluorine atoms (F), 100 mass ppm or less is preferable, 50 mass ppm or less is more preferable, 30 mass ppm or less is further preferable, 10 mass ppm or less is further preferable, and 5 mass ppm or less is further preferable. When using tin compound (B1) as a resist material for the most advanced fine semiconductor processes (e.g., EUV), 10 mass ppm or less is preferable, 5 mass ppm or less is more preferable, and 3 mass ppm or less is further preferable. In particular, for chlorine atoms (C₁), it is preferable to have 10 mass ppm or less, 5 mass ppm or less is more preferable, and 3 mass ppm or less is further preferable. This is because there is a high risk of Cl atoms being introduced from the raw materials used and the equipment and devices used in the manufacturing process, and Cl atoms can potentially cause corrosion of semiconductor process devices, as well as increase outgassing, pattern defects, short circuits, or corrosion of metal wiring. Therefore, it is preferable to reduce the Cl content among the halogen atoms.

### <Halogen Content Measurement>

The method for measuring halogen content is not particularly limited, but it is preferable to have a detection sensitivity of 10 mass ppm or less, and more preferably 1 mass ppm or less, for each halogen atom at the detection limit. Specific methods are shown in the examples, but for example, the following methods may be used, and they are implemented by combining the pretreatment methods and analysis methods described below.

As pretreatment methods, it is preferable to use methods that can recover halogen atoms from the target tin compound with high recovery rate, high accuracy, and high reproducibility, such as combustion absorption methods or acid decomposition methods. As methods for achieving the aforementioned detection sensitivity, for example, methods for quantifying using ion chromatography (IC) or inductively coupled plasma mass spectrometry (ICP-MS) can be used. By combining these pretreatment methods and analysis methods appropriately, it is possible to analyze the halogen content of the target tin compound.

### <Halogen Reduction Method>

Methods for reducing halogen atoms in tin compound (B1) include (1) reducing the halogen content in the raw materials, (2) removing halogen atoms by purifying the obtained tin compound (B1), and (3) reducing the introduction of halogen atoms from the equipment, containers, or environment used. These methods are explained below.

### (1) Method for Reducing Halogen Content in Raw Materials

While it is possible to use raw materials that contain halogen in the structure of tin compound (B1), it is preferable to use raw materials with a low content of halogen atoms in their structure. When using raw materials that contain multiple halogen atoms (F, Cl, Br, I), either in their structure or as impurities, it is necessary to employ specific purification methods for each type of halogen, and there is a possibility that impurities containing different boiling point halogens may be generated. Therefore, it is preferable for the raw materials containing halogen atoms to have only one type of halogen atom, and in particular, it is preferable for the halogen atom to be Cl, as it is easier to separate and more stable in distillation purification. The specific content of halogen atoms in the raw materials is preferably 1 mass % or less, more preferably 0.5 mass % or less, further preferably 0.1 mass % or less, and further more preferably 0.01 mass % or less.

### (2) Method for Removing Halogen Atoms by Purifying the Obtained Tin Compound (B1)

Methods for reducing halogen atoms in tin compounds by purification may be implemented by combining various purification methods. For example, filtration of insolubles, liquid-liquid separation (using ultrapure water, etc.), column chromatography, removal using reaction agents or chelating agents, adsorption treatment using resins, distillation purification, etc. may be used. However, when tin compound (B1) has reactivity towards water or functional groups, the purification methods are limited, and it is preferable to perform distillation purification. In particular, a distillation method using a distillation column as mentioned above (for example, fifth embodiment) is applicable, but it is preferable to use a distillation column with SUS-made regular packing material, as the SUS-made regular packing material efficiently adsorbs trace halogen impurities, promoting separation. Additionally, when tin compounds containing Sn-halogen bonds are present as impurities and their boiling points are close to that of the target tin compound (B1), it is preferable to use a distillation method with the high separation efficiency distillation column (packing material, number of theoretical plates, heating equipment, etc.) included in this invention for example, as described in the first to fifth aspects of the disclosure. Furthermore, by setting a low reflux ratio to remove the initial distillate during distillation, and then setting the reflux ratio to obtain high-purity tin compound (B1) (for example, second aspect of the disclosure), it is possible to remove halogen impurities that have been decomposed during heating as low-boiling point fractions, which is a preferable method.

(3) Method for Reducing the Introduction of Halogen Atoms from Equipment, Containers, or Environment Used

When removing halogen components during distillation, it is necessary to prevent the introduction of halogens from the equipment used for distillation. In particular, when tin compound (B1) is in a liquid or gaseous state at high temperatures during distillation, it has the property of dissolving both organic halogen compounds and inorganic halogen compounds, and therefore, more attention is required for the elution and introduction of halogens from the equipment and devices used, compared to the distillation of normal organic compounds. When using SUS-made equipment, it is preferable to use SUS with high corrosion resistance or SUS with corrosion-resistant surface treatment. Specifically, it is preferable to use SUS316 or SUS304, and it is further preferable to use those with corrosion-resistant surface treatment. When using SUS-made or glass-made equipment, it is preferable to perform heating reflux washing with a solvent containing an alcohol (methanol, ethanol, isopropanol, etc.) under sufficient reflux conditions. In addition, by combining washing with other non-protonic organic solvents (acetone, heptane, toluene, etc.) in addition to alcohol solvent washing, it is possible to remove a wider range of impurities, including lipophilic halogen impurities and water-soluble halogen impurities, which is more preferable. Furthermore, for the container used to fill the obtained tin compound (B1) (storage container), it is preferable to use a container that has been sufficiently washed, and in particular, a container that has been washed with ultrapure water and dried is preferable.

Additionally, the introduction of halogen atoms from the environment may occur from the human body, protective gloves, the atmosphere, etc. To prevent this, it is preferable to directly fill the container without exposing it to the atmosphere after distillation. It is also preferable to perform manufacturing in an environment with reduced halogens, such as in a clean room where the distillation equipment is located.

### <Metal Content>

In this embodiment, the metal content in tin compound (B1) refers to the content of metal elements (other than tin) in the tin compound, which is expressed in units such as mass %, mass ppm, or mass ppb. The target metal elements are not particularly limited, but examples include Ag, Al, Au, B, Ca, Co, Li, Mg, Mn, Mo, Na, Ni, Pb, W, Zn, and Zr. In particular, for the most advanced fine semiconductor processes (e.g., EUV), there is a high possibility that trace metal impurities in the semiconductor material may cause issues such as increased outgassing, pattern defects, short circuits, or corrosion of metal wiring, leading to potential performance degradation or reduced yield, and thus, more stringent management is required. The preferred range of metal content in tin compound (B1) is as follows: for each metal, 10 mass ppm or less is preferable, 1 mass ppm or less is more preferable, 100 mass ppb or less is further preferable, 50 mass ppb or less is further preferable, and 10 mass ppb or less is further preferable. When using tin compound (B1) as a resist material for the most advanced fine semiconductor processes (e.g., EUV), 10 mass ppb or less is preferable, 5 mass ppb or less is more preferable, and 1 mass ppb or less is further preferable.

### <Metal Content Measurement>

The method for measuring metal content is not particularly limited, but it is preferable to have a detection sensitivity of 10 mass ppb or less, and more preferably 1 mass ppb or less, for each metal element at the detection limit. Specific methods are shown in the examples, but for example, the following methods may be used, and they are implemented by combining the pretreatment methods and analysis methods described below.

As pretreatment methods, it is preferable to use methods that can recover metal elements from the target tin compound with high recovery rate, high accuracy, and high reproducibility, such as combustion absorption methods or acid decomposition methods. As methods for achieving the aforementioned detection sensitivity, for example, methods for quantifying using ion chromatography (IC) or inductively coupled plasma mass spectrometry (ICP-MS) may be used. By combining these pretreatment methods and analysis methods appropriately, it is possible to analyze the metal content of the target tin compound.

### <Metal Element Reduction Method>

Methods for reducing metal elements in tin compound (B1) include (1) reducing the metal content in the raw materials, (2) removing metal elements by purifying the obtained tin compound (B1), and (3) reducing the introduction of metal elements from the equipment, containers, or environment used. These methods are explained below.

### (1) Method for Reducing Metal Content in Raw Materials

While it is possible to use raw materials that contain metals in tin compound (B1), it is preferable to use raw materials with a low content of metal elements. The specific content of metal elements which are not present in the chemical structure of the raw materials is preferably 1 mass % or less, more preferably 0.5 mass % or less, further preferably 0.1 mass % or less, further more preferably 0.01 mass % or less, 10 mass ppm or less is preferable, 1 mass ppm or less is preferable, 100 mass ppb or less is preferable, and 10 mass ppb or less is further preferable. In particular, for the metal content not included in the chemical structure of the raw materials used for resist materials for the most advanced semiconductor processes, it is preferable to control it for the purpose of stably manufacturing uniform materials, and the content is preferably 10 mass ppb or less, and more preferably 1 mass ppb or less.

### (2) Method for Removing Metal Elements by Purifying the Obtained Tin Compound (B1)

Methods for reducing metal elements in tin compounds by purification may be implemented by combining various purification methods. For example, filtration of insolubles, liquid-liquid separation (using ultrapure water, etc.), column chromatography, removal using reaction agents or chelating agents, adsorption treatment using resins, distillation purification, etc. can be used. However, when tin compound (B1) has reactivity towards water or functional groups, the purification methods are limited, and it is preferable to perform distillation purification. In particular, a distillation method using a distillation column as mentioned above is applicable, but it is preferable to use a distillation column with SUS-made regular packing material, as the SUS-made regular packing material efficiently adsorbs trace metal impurities, promoting separation. Additionally, to reduce the metal components that may elute from SUS during distillation, it is preferable to set a low reflux ratio to remove the initial distillate in a short time, and then set the reflux ratio to obtain high-purity tin compound (B1) to obtain the main distillate.

(3) Method for Reducing the Introduction of Metal Elements from Equipment, Containers, or Environment Used

When removing metal components during distillation, it is necessary to prevent the introduction of metals from the equipment used for distillation. In particular, when tin compound (B1) is in a liquid or gaseous state at high temperatures during distillation, there is a possibility of eluting metal components, and the oxidation-reduction characteristics possessed by tin compound (B1) may cause corrosion of metal-made equipment and elution of metals. Therefore, more attention is required for the elution and introduction of metals from the equipment and devices used, compared to the distillation of normal organic compounds. When using SUS-made equipment, it is preferable to use SUS with high corrosion resistance or SUS with corrosion-resistant surface treatment. Specifically, it is preferable to use SUS316 or SUS304, and it is further preferable to use those with corrosion-resistant surface treatment. When using SUS-made or glass-made equipment, it is preferable to perform heating reflux washing with a solvent containing an alcohol (methanol, ethanol, isopropanol, etc.) under sufficient reflux conditions. In particular, when using SUS-made equipment, it is more preferable to combine washing with other non-protonic organic solvents (acetone, heptane, toluene, etc.) in addition to alcohol solvent washing, as it allows for the removal of a wider range of impurities, including lipophilic metal impurities and water-soluble metal impurities. Furthermore, for the container used to fill the obtained tin compound (B1), it is preferable to use a container that has been sufficiently washed, and in particular, a container that has been washed with ultrapure water and dried is preferable.

Additionally, the introduction of metal elements from the environment may occur from the human body, protective gloves, the atmosphere, etc. To prevent this, it is preferable to directly fill the container without exposing it to the atmosphere after distillation. It is also preferable to perform manufacturing in an environment with reduced halogens, such as in a clean room where the distillation equipment is located.

### <Simultaneous Reduction of Halogen Atoms and Metal Elements>

As mentioned above, halogen atoms and metal elements that are present as impurities may cause various problems (increased outgassing, pattern defects, short circuits, or corrosion of metal wiring, etc.) in semiconductor processes, either as individual factors or through synergistic effects. Therefore, it is preferable to reduce them. In particular, by simultaneously managing the halogen content and metal content to be below specific values, it is possible to quickly analyze and solve the causes of problems in semiconductor processes, which may highly stabilize the process yield. The specific combination of halogen atom and metal element contents is as follows: it is preferable to have each halogen atom at 500 mass ppm or less and each metal element at 100 mass ppb or less, it is more preferable to have each halogen atom at 50 mass ppm or less and each metal element at 100 mass ppb or less, it is more preferable to have each halogen atom at 30 mass ppm or less and each metal element at 100 mass ppb or less, it is further preferable to have each halogen atom at 10 mass ppm or less and each metal element at 100 mass ppb or less, and it is further preferable to have each halogen atom at 10 mass ppm or less and each metal element at 10 mass ppb or less. In particular, in the aforementioned combination, it is further preferable to have Cl atoms at 5 mass ppm or less, and it is further preferable to have Cl atoms at 3 mass ppm or less.

### <Simultaneous Reduction of Halogen Atoms and Metal Elements and High Purity>

Even when the halogen atoms and metal elements are reduced as mentioned above, it is necessary to achieve both the distillation purification for obtaining a sufficiently high-purity tin compound (B1). The purity to be achieved is preferably 95 mol % or more, more preferably 97 mol % or more, further preferably 98 mol % or more, and further more preferably 99 mol % or more. Additionally, for the content of impurities (B2), (B3), and (B4), it is preferable to have each of them at 2 mol % or less, more preferably 1 mol % or less, and further more preferably 0.5 mol % or less. When these conditions are met, it is possible to use tin compound (B1) as a high-quality resist material with a particularly high purity, which may contribute to reducing outgassing and pattern defects in semiconductor processes.

The purified tin compound obtained by this purification method may maintain high purity for a long period of time, and therefore, it is particularly suitable not only for storage in containers but also for storage and/or transportation.

The purified tin compound may be stored for a short to a long period of time, ranging from about 3 days to about 1 year, by storing it at a temperature of less than about 30° C. without substantial light exposure. For example, it may be stored for a period of about 1 week to about 10 months, about 2 weeks to 6 weeks, or any desired duration.

The storage temperature of the purified tin compound is preferably less than about 30° C., more preferably less than about 25° C., and further more preferably less than about 20° C. As for the lower limit of the storage temperature, it is preferable to be above about −10° C.

The phrase “without substantial light exposure” may be understood to mean that the purified tin compound is protected from light exposure as much as possible, such as by storing it in amber-colored or stainless steel containers. In this embodiment, the purified tin compound (i.e., high-purity tin compound A1) does not undergo substantial decomposition after storage for about 3 days to about 1 year as mentioned above.

### [Applications of Tin Compounds A1 or B1]

The purified tin compound obtained by this purification method is useful as a material for EUV resists and other applications due to its high purity as a tin compound A1.

The purified tin compound may be further diluted with a solvent as needed to form a composition containing the tin compound. It is preferable to dilute the purified tin compound with a solvent to make it easier to apply or deposit as a resist material. As for the solvent, there is no particular limitation, but organic solvents such as alcohol-based, ether-based, ketone-based, amide-based, and ester-based solvents are preferable, and alcohol-based solvents are more preferable. These solvents may be used alone or in combination of two or more.

As for the alcohol-based solvent, for example, aliphatic or cycloaliphatic alcohols may be used, and either monoalcohols or polyhydric alcohols may be used. It is also possible to use partial ether-based solvents of polyhydric alcohols. The number of carbon atoms is not particularly limited, and for example, those with 2 to 18 carbon atoms can be used.

Additionally, it is preferable for the solvent itself to not contribute to metal contamination.

The amount of solvent used is preferably 0.01 to 30 parts by mass, more preferably 0.1 to 20 parts by mass, and further more preferably 1 to 10 parts by mass, based on 1 part by mass of the purified tin compound.

The purified tin compound may be used as a resist material after undergoing a reaction such as hydrolysis. For example, the method disclosed in JP 2021-21953 A may be used for the method of using the resist material. It is possible to form an alkyltin oxo-hydroxo patterning composition represented by the formula RSnO_{(3/2-x2)}(OH)ₓ (where 0<x≤3) by hydrolyzing with water or another suitable reagent under appropriate conditions, which includes a base that can be changed into a composition by a hydrolysis and condensation reaction that is possible with a substituent (X) that may undergo hydrolysis and other reactions. The following reactions are shown as examples.

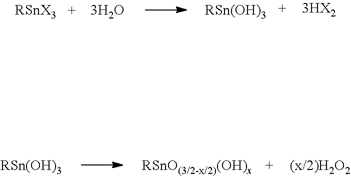

Alkyl oxo-hydroxystannane compounds [formula] RSnO_{(3/2-x/2)}(OH)_{X} (where 0<x<3), obtained by hydrolyzing tin compound A1 (or a composition containing tin compound A1) as a raw material, may be used as EUV resist materials.

Methods for obtaining tin compound P1 by hydrolyzing tin compound A1 or B1 (or a composition containing tin compound A1 or B1) include, for example, methods of reacting water vapor or the like with the vapor generated by heating or reducing the pressure of tin compound A1 (or a composition containing tin compound A1), or with the substrate on which tin compound A1 (or a composition containing tin compound A1) has been deposited (dry method). With this method, it is possible to form a thin film (film) containing tin compound P1 on the thin film (film) substrate.

There is also a method of obtaining tin compound P1 by reacting tin compound A1 (or a composition containing tin compound A1) in solution or solid state with water or the like to perform hydrolysis. Subsequently, tin compound P1 may be used as a coating solution by dissolving it in an organic solvent or the like.

This solution may be coated onto a substrate using any coating or printing technique, and a thin film (coating film) containing tin compound P1 may be formed on the substrate.

The thin film obtained by any of the above methods may be stabilized or partially condensed before light exposure through processes such as drying or heating. In general, the thin film is thin, and for example, it may have an average thickness of less than 10 microns, and in some cases, it is desirable to have a very thin sub-micron thin film with a thickness of less than 100 nanometers (nm), or even less than 50 nm, or particularly less than 30 nm, for patterning very small features. The obtained thin film may be treated so that a portion of the composition becomes resistant to development/etching by exposure, and thus, it may be referred to as a “resist.”

The thin film may be exposed to an appropriate radiation, such as extreme ultraviolet, electron beam, or ultraviolet, using a selected pattern or the negative of the pattern, to form a latent image with areas resistant to the developer and areas soluble in the developer. After exposure to the appropriate radiation and before development, the thin film may be heated or otherwise reacted to differentiate the latent image from the unexposed areas. The latent image is contacted with a developer to form a physical image, i.e., a patterned thin film. The patterned thin film may be further heated to stabilize the patterned residual thin film on the surface. The patterned thin film may be used as a physical mask for further processing, such as etching the substrate and/or attaching additional materials, according to the pattern. After using the patterned resist as desired, the remaining patterned thin film may be removed at an appropriate stage of processing, but the patterned thin film may also be incorporated into the final structure.

### EXAMPLES

The following examples are provided to further illustrate the invention, but the invention is not limited to these examples. Unless otherwise specified, “parts” and “%” in the examples refer to mass standards.

The following is a detailed description of the examples performed using distillation. In some cases, the tin compounds may be referred to as follows. The peak shifts (ppm) in ¹¹⁹Sn-NMR are also shown.

### [Target Tin Compound (A1)]

iPrSn(NMe₂)₃:Isopropyltris(dimethylamide)tin,¹¹⁹Sn-NMR:−64ppm Compound (1)

[Impurity Tin Compounds (A2, A3, A4)]

iPr₂Sn(NMe₂)₂:Diisopropyl compound, ¹¹⁹Sn-NMR: −18 ppm Compound (2)

Sn(NMe₂)₄:Tetrakisamide compound,¹¹⁹Sn-NMR: −119ppm Compound (3)

iPrSn(NMe₂)₂(N(Me)CH²NMe₂)₂¹¹⁹Sn-NMR: −82 ppm Compound (4)

### First Embodiment

First, distillation of a composition containing tin compound (1) was performed under the distillation conditions shown in Table 1 below. Detailed examples are shown below.

TABLE 1-1

| | Number of | Reflux |
|---|---|---|
| | theoretical plates | Ratio |
| Example 1-1 | 30 | 10 |
| Comparative | 30 | 100 |
| Example 1-1 | | |
| Comparative | 30 | 50 |
| Example 1-2 | | |

### Example 1-1

A distillation apparatus equipped with a Jim Roth condenser, a horizontal automatic reflux device (Asahi Glass Co., Ltd.), a glass distillation column (Asahi Glass Co., Ltd.) [packing material: regular packing material Sulzer Ex Laboratory Packing ID25 mm (Sulzer Chemtech Ltd.), packing height: 1120 mm (1.120 m), inner diameter: 25 mm, vacuum-insulated jacket, light-shielded plating, number of theoretical plates: 30 plates (calculated value in n-heptane/methylcyclohexane system), HETP: 1.120 (m)/30 (plates)=0.037 (m/plate)], a jacketed 500 mL separable flask (Asahi Glass Co., Ltd.), a magnetic stirrer, an oil pump (ULVAC Inc., GCD-051X), and a pressure gauge (at the top of the tower) was used for distillation. All glass parts were shielded with aluminum foil.

The entire distillation apparatus was purged with nitrogen using an oil pump. A separable flask was filled with 362 g of tin compound (1) before distillation under a nitrogen atmosphere, and the pressure inside the distillation apparatus was reduced to 3.0 torr. Subsequently, the jacket oil of the separable flask was heated to 107° C., and the system was operated under total reflux for 2 hours.

After that, the distillation was started with a reflux ratio of 10, and the distillate (distillate) was fractionated. 1.5 hours of the distillate were collected as “Fr1,” the receiver was changed, and 1.5 hours of the distillate were collected as “Fr2.” The receiver was changed again, and 1.5 hours of the distillate were collected as “Fr3.” The receiver was changed once more, and 1.5 hours of the distillate were collected as “Fr4.” After that, the system was switched to total reflux, and it was cooled to room temperature (23° C.) and pressurized back to atmospheric pressure with nitrogen.

During distillation, the pressure at the top of the tower was 1.8-3.2 torr, the top temperature was 58-68° C., the internal temperature of the distillation pot was 94-97° C., and the jacket temperature was 104-107° C.

The mass and ¹¹⁹Sn-NMR composition of the distillation raw material, the distillate obtained by distillation (Fr1-4), and the residue (Pot remaining) left in the reactor after distillation are shown in the following table.

TABLE 1-2

| | | | Sn-NMR (ppm) | | | |
|---|---|---|---|---|---|---|
| | | Mass of | | | −82 | |
| | | the tin | −18 | −64 | Compound (4) | −119 |
| | | compound | Compound (1) | Compound (2) | iPrSn(NMe₂)₂ | Compound (3) |
| | | [g] | iPrSn(NMe₂)₃ | iPr₂Sn(NMe₂)₂ | (N(Me)CH₂NMe₂) | Sn(NMe₂)₄ |
| Before distillation | | 355.9 | 87.88 | 7.36 | 0.72 | nd |
| After | Fr1 | 31.9 | 97.99 | 0.07 | 0.14 | 1.80 |
| distillation | Fr2 | 37.2 | 98.87 | 0.07 | 0.14 | 0.92 |
| | Fr3 | 32.5 | 99.05 | 0.09 | 0.23 | 0.63 |
| | Fr4 | 37.2 | 99.13 | 0.09 | 0.24 | 0.55 |
| | distillation | 217.2 | 80.50 | 12.1 | 0.61 | 0.32 |
| | pot | | | | | |

### Comparative Example 1-1

The same distillation apparatus as in Example 1 was used. The entire distillation apparatus was purged with nitrogen using an oil pump. A separable flask was filled with 471 g of tin compound (1) under a nitrogen atmosphere, and the pressure inside the distillation apparatus was reduced to 3.0 torr. Subsequently, the jacket oil of the separable flask was heated to 107° C., and the system was operated under total reflux for 1 hour. After that, the distillation was started with a reflux ratio of 100, and the distillate was fractionated. 3 hours of the distillate were collected as “Fr1,” the receiver was changed, and 3 hours of the distillate were collected as “Fr2.” Then, 10 hours of the distillate were collected as “Fr3,” and another 10 hours of the distillate were collected as “Fr4.” After that, the system was switched to total reflux, and it was cooled to room temperature and pressurized back to atmospheric pressure with nitrogen.

During distillation, the pressure at the top of the tower was 2.0-4.0 torr, the top temperature was 70-80° C., the internal temperature of the distillation pot was 94-97° C., and the jacket temperature was 104-107° C.

The mass and ¹¹⁹Sn-NMR composition of the distillation raw material and the distillates Fr1-4 obtained by distillation are shown in the following table.

TABLE 1-3

| | | Mass of | | | | |
|---|---|---|---|---|---|---|
| | | the tin | | | Compound (4) | |
| | | compound | Compound (1) | Compound (2) | iPrSn(NMe₂)₂ | Compound (3) |
| | | [g] | iPrSn(NMe₂)₃ | iPr₂Sn(NMe₂)₂ | (N(Me)CH₂NMe₂) | Sn(NMe₂)₄ |
| Before distillation | | 471.0 | 93.37 | 5.74 | 0.62 | nd |
| After | Fr1 | 2.1 | 92.02 | nd | 4.09 | 3.67 |
| distillation | Fr2 | 11.1 | 93.08 | nd | 1.32 | 5.47 |
| | Fr3 | 33.7 | 93.80 | nd | 0.87 | 5.20 |
| | Fr4 | 32.7 | 94.31 | nd | 1.90 | 3.76 |
| | distillation | 378.0 | 87.88 | 7.36 | 0.72 | nd |
| | pot | | | | | |

### Comparative Example 1-2

The same apparatus as in Example 1 was used. The entire distillation apparatus was purged with nitrogen using an oil pump. A separable flask was filled with 421 g of tin compound (1) under a nitrogen atmosphere, and the pressure inside the distillation apparatus was reduced to 3.0 torr. Subsequently, the jacket oil of the separable flask was heated to 107° C., and the system was operated under total reflux for 1 hour. After that, the distillation was started with a reflux ratio of 50, and the distillate was fractionated. 3 hours of the distillate were collected as “Fr1,” the receiver was changed, and 6 hours of the distillate were collected as “Fr2.” Then, 6 hours of the distillate were collected as “Fr3,” and another 13 hours of the distillate were collected as “Fr4.” After that, the system was switched to total reflux, and it was cooled to room temperature and pressurized back to atmospheric pressure with nitrogen.

During distillation, the pressure at the top of the tower was 2.0-4.0 torr, the top temperature was 63-73° C., the internal temperature of the distillation pot was 94-97° C., and the jacket temperature was 104-107° C.

The mass and ¹¹⁹Sn-NMR composition of the distillation raw material and the distillates Fr1-4 obtained by distillation are shown in the following table.

TABLE 1-4

| | | Tin | | | | |
|---|---|---|---|---|---|---|
| | | compounds | | | Compound (4) | |
| | | Mass | Compound (1) | Compound (2) | iPrSn(NMe₂)₂ | Compound (3) |
| | | [g] | iPrSn(NMe₂)₃ | iPr₂Sn(NMe₂)₂ | (N(Me)CH₂NMe₂) | Sn(NMe₂)₄ |
| Before distillation | | 421.32 | 93.39 | 5.36 | 0.69 | 0.19 |
| After | Fr1 | 14.84 | 96.80 | nd | 0.17 | 2.93 |
| distillation | Fr2 | 30.00 | 97.25 | nd | 0.21 | 2.54 |
| | Fr3 | 27.75 | 92.77 | nd | 0.22 | 6.96 |
| | Fr4 | 56.00 | 92.42 | nd | 0.15 | 7.39 |
| | distillation | 244.48 | 85.07 | 9.45 | 0.83 | 0.14 |
| | pot | | | | | |

From Table 1-1 to 1-4, it may be seen that by using a distillation apparatus with a high number of theoretical plates and setting the reflux ratio to a low value to quickly collect the distillate, as shown in Example 1-1, it is possible to suppress the generation of by-products such as compounds (3) and (4) due to decomposition, while removing the dialkyl compound (2), and obtain high-purity monoalkylstannane compound (1).

### Second Embodiment

### Example 2-1

The following distillation apparatus and experimental operation were performed, and distillation including processes 1 and 2 was carried out to obtain high-purity tin compounds as distillates.

### [Experimental Apparatus]

A distillation apparatus equipped with a Jim Roth condenser, a horizontal automatic reflux device (Asahi Glass Co., Ltd.), a glass distillation column (Asahi Glass Co., Ltd.) [packing material: regular packing material Sulzer Ex Laboratory Packing ID25 mm (Sulzer Chemtech Ltd.), packing height: 1120 mm, inner diameter: 25 mm, vacuum-insulated jacket, light-shielded plating, number of theoretical plates: 30 plates (calculated value in n-heptane/methylcyclohexane system), HETP: 1.120 (m)/30 (plates)=0.037 (m/plate)], a jacketed 500 mL separable flask (Asahi Glass Co., Ltd.), a magnetic stirrer, an oil pump (ULVAC Inc., GCD-051X), and a pressure gauge (at the top of the tower) was used for distillation. All glass parts were shielded with aluminum foil. The distillation apparatus was used after sufficient drying by reflux washing with heptane, reflux washing with methanol, and N₂ circulation.

The entire distillation apparatus was purged with nitrogen using an oil pump. A separable flask was filled with 426 g of tin compound (crude tin compound) before distillation under a nitrogen atmosphere, and the pressure inside the distillation apparatus was reduced to 400 Pa. Subsequently, the jacket oil of the separable flask was heated to 108° C., and the system was operated under total reflux for 30 minutes without collecting any distillate until the top temperature reached 65° C.

### (Process 1)

When the top temperature reached 65° C., the reflux device was switched to all withdrawal with a reflux ratio of 0, and the distillate collected for 15 minutes was obtained as “Fr1.” After that, the reflux device was set to total reflux, and the system was operated for 35 minutes without collecting any distillate.

### (Process 2)

Next, the distillation was started with a reflux ratio of 10, and the distillate was fractionated. 1.5 hours of the distillate were collected as “Fr2,” the receiver was changed, and 1.5 hours of the distillate were collected as “Fr3.” The receiver was changed again, and 1.5 hours of the distillate were collected as “Fr4.” After that, the system was switched to total reflux, and it was cooled to room temperature (23° C.) and pressurized back to atmospheric pressure with nitrogen, and it was kept under a nitrogen atmosphere until the next day. The next day, the pressure inside the distillation apparatus was reduced to 400 Pa. Subsequently, the jacket oil of the separable flask was heated to 110° C., and the system was operated under total reflux for 30 minutes after the top temperature reached 66° C. After that, the distillation was started with a reflux ratio of 10, and the distillate was fractionated. 1.5 hours of the distillate were collected as “Fr5,” and then the jacket oil was heated to 112° C., the receiver was changed, and 1.5 hours of the distillate were collected as “Fr6.” After that, the system was switched to total reflux, and it was cooled to room temperature and pressurized back to atmospheric pressure with nitrogen, and it was kept under a nitrogen atmosphere until the next day.

During distillation (processes 1 and 2), the pressure at the top of the tower was 378-405 Pa, the top temperature was 65-66° C., and the internal temperature of the distillation pot was 93-97° C. The mass and ¹¹⁹Sn-NMR composition of the distillation raw material, the distillates Fr1-6 obtained by distillation, and the residue left in the distillation pot (Pot remaining) are shown in the following table.

TABLE 2-1

| | | Mass | | | | |
|---|---|---|---|---|---|---|
| | | of Tin | | | Compound (4) | |
| | | compound | Compound (1) | Compound (2) | iPrSn(NMe₂)₂ | Compound (3) |
| | | [g] | iPrSn(NMe₂)₃ | iPr₂Sn(NMe₂)₂ | (N(Me)CH₂NMe₂) | Sn(NMe₂)₄ |
| Before distillation | | 426.28 | 99.30% | 0.20% | 0.48% | — |
| After | Fr1 (all | 93.52 | 99.71% | 0.08% | 0.02% | 0.12% |
| distillation | withdrawals) | | | | | |
| | Fr2 | 44.38 | 99.61% | — | 0.03% | 0.31% |
| | Fr3 | 41.02 | 99.53% | — | 0.04% | 0.42% |
| | Fr4 | 36.84 | 99.51% | — | 0.07% | 0.40% |
| | Fr5 | 27.12 | 99.18% | — | 0.15% | 0.59% |
| | Fr6 | 27.71 | 99.09% | — | 0.13% | 0.70% |
| | Distillation | 129.15 | 94.78% | 1.11% | 1.14% | — |
| | pot | | | | | |
| | Total of | 177.07 | 99.42% | — | 0.08% | 0.46% |
| | Fr2~6 | | | | | |

From the above table, the amounts of distillate obtained in process 1 [Fr1 (total reflux conditions)] and process 2 [Fr2-6 (reflux ratio 10)] relative to the total amount of distillate are shown in the following table.

TABLE 2-2

| | | Amount of distillate | Percentage of distillate |
|---|---|---|---|
| | | (g) | (%) |
| Process 1 | Fr1 | 93.52 | 34.6 |
| Process 2 | Fr2~6 | 177.07 | 65.4 |

| | | |
|---|---|---|
| Total amount of distillate | 270.59 | 100.0 |

From Table 2-1 to 2-2, it can be seen that by using the specific distillation conditions including processes 1 and 2 as shown in Example 2-1, it is possible to suppress the generation of by-products (3) and (4) due to decomposition during distillation and obtain high-purity tin compounds (1). Specifically, it was possible to obtain high-purity tin compounds (1) from both the distillate obtained in process 1 and the distillate obtained in process 2, and in particular, it was possible to obtain extremely high-purity tin compounds (1) without by-products (2) with similar boiling points from the distillate obtained in process 2.

The content of halogen atoms (F, Cl, Br, I) and metal elements other than tin in the tin compound (1) in the distillate obtained in process 2 (Fr2) were measured. The measurement methods and detection limits are described below, and the measurement results are shown in Table 2-3 and Table 2-4.

### <Halogen Content Measurement>

### [Measurement of F and Cl Content]

The absorption solution obtained by the combustion absorption method of tin compound (1) was analyzed by ion chromatography (IC), and the contents of F and Cl in tin compound (1) were measured.

### (Combustion Absorption IC Method)

Combustion absorption device: HF-210, GA-211, manufactured by Nitto Seiko Analytic Co., Ltd.
IC analysis device: ICS-5000, manufactured by Thermofisher Scientific
Detection limit: 10 mass ppm for F, 1 mass ppm for Cl

### [Measurement of Br and I Content]

The contents of Br and I in tin compound (1) were measured by analyzing the solution after decomposing tin compound (1) with an acid aqueous solution by inductively coupled plasma mass spectrometry (ICP-MS).

### (Acid Decomposition ICP-MS Method)

ICP-MS analysis device: ELEMENT2, manufactured by ThermoFisher Scientific
Detection limit: less than 10 mass ppm for Br, less than 10 mass ppm for I

TABLE 2-3

contents (mass ppm, μg/g)

| Sample | F | Cl | Br | I |
|---|---|---|---|---|
| Fr2 | <10 | 3.9 | <10 | <10 |

### <Analysis of Metal Elements Other Than Tin>

The content of metal elements other than tin in tin compound (1) was measured by analyzing the solution after decomposing tin compound (1) with an acid aqueous solution by inductively coupled plasma mass spectrometry (ICP-MS).

### (Acid Decomposition ICP-MS Method)

ICP-MS analysis device: ELEMENT2, manufactured by ThermoFisher Scientific
Detection limit: 10 mass ppb for each element listed in Table 2-4

TABLE 2-4

| Kind of | contents (mass |
|---|---|
| elements | ppb, ng/g) |
| Ag | <10 |
| Al | <10 |
| Au | <10 |
| B | <10 |
| Ca | <10 |
| Co | <10 |
| Li | <10 |
| Mg | <10 |
| Mn | <10 |
| Mo | <10 |
| Na | <10 |
| Ni | <10 |
| Pb | <10 |
| W | <10 |
| Zn | <10 |
| Zr | <10 |

As shown in Table 2-3, the content of halogen atoms (F, Cl, Br, I) was less than 10 mass ppm for each. In particular, the content of Cl atoms, which are a concern for contamination from the raw materials used and from the equipment, containers, and environment, was extremely low.

Furthermore, as shown in Table 2-4, the content of metal elements other than tin was less than 10 mass ppb for each. In this way, tin compound (1) has a high purity and meets the extremely low halogen content and metal element content required for semiconductor materials.

### Third Embodiment

### Example 3-1

### [Distillation Apparatus]

A distillation apparatus equipped with a 1L four-necked flask (Asahi Glass Co., Ltd.) as a heating vessel, a Jim Roth condenser, a magnetic stirrer, an oil bath filled with silicone oil (Momentive Performance Materials Japan LLC, TSF458-100), an oil pump (ULVAC Inc., GCD-051X), and a pressure gauge was used. Aluminum foil was wrapped around all glass parts of the Jim Roth condenser for light shielding and insulation.

The entire reduced-pressure heating apparatus was purged with nitrogen using an oil pump. A 1 L flask was filled with 352 g of crude tin compound before distillation under a nitrogen atmosphere, and the pressure inside the flask was reduced to 3 torr. Subsequently, the flask was immersed in the oil bath until the liquid level inside the flask was lower than the liquid level of the oil bath. The heat transfer area, which is the area where the liquid of the crude tin compound filled in the flask comes into contact with the oil through the glass surface of the flask, was measured as 183 cm². Thus, the heat transfer area per mass of the tin compound was calculated as 0.61 cm²/g (183 (cm²)/352 (g)).

In that state, stirring was performed while heating the oil bath to 107° C., and the crude tin compound was volatilized by reduced-pressure heating while total reflux was performed using the cooling condenser, and the system was stabilized under equilibrium conditions. The system was held for 14 hours in that state (internal temperature: 92° C., jacket (JK) temperature: 107° C.). After that, the reduced pressure and heating were stopped, and after confirming that all tin compounds in the distillation apparatus had returned to the flask, sampling of the tin compound in the flask was performed under a nitrogen atmosphere, and the composition was confirmed by analysis using ¹¹⁹Sn-NMR. The results are shown in the table below.

### Comparative Example 3-1

The heating vessel for filling tin compound (1) was a 100 mL four-necked flask, and the filling amount of tin compound (1) was 31 g. The same experiment as Example 3-1 was performed. At that time, the heat transfer area was 35 cm², and the heat transfer area per mass was 1.34 cm²/g. The results at that time are shown in the table below.

TABLE 3

| | | | | | Heat | | | | |
|---|---|---|---|---|---|---|---|---|---|
| | | | | | transfer | | | | |
| | | | | | area per | | | | |
| | | | | | mass of | | | Cmpd (4) | |
| | Heating | | Internal | JK | e tin | Cmpd (1) | Cmpd (2) | iPrSn(NMe₂)₂ | Cmpd (3) |
| | vessel | | temp | temp* | compound | iPrSn(NMe₂)₃ | iPr₂Sn(NMe₂)₂ | (N(Me)CH₂NMe₂) | Sn(NMe₂)₄ |
| Before | — | | — | — | — | 99.19% | 0.22% | 0.60% | 0% |
| distillation | | | | | | | | | |
| Example 3-1 | 1 | L | 92° C. | 107° C. | 0.61 | 97.07% | 0.23% | 2.15% | 0.36% |
| Comparison | 100 | mL | 90° C. | 106° C. | 1.34 | 96.62% | 0.24% | 2.13% | 0.84% |
| Example 3-1 | | | | | | | | | |

*JK temp = Jacket temperature

In Example 3-1, where the heat transfer area per mass is small, the decomposition of tin compound (1) under distillation conditions was suppressed, resulting in the suppression of the by-product tetrakis compound (3), and a higher purity was maintained.

### Fourth Embodiment

### Example 4-1

Distillation of crude tin compound was performed using a distillation apparatus with an upper outlet and an intermediate outlet as shown below. Note that FIG. 1 is a reference diagram of this distillation apparatus, and the details are different.

### [Distillation Apparatus]

A distillation apparatus with a SUS-made heating distillation pot, distillation column, and vacuum pump connected was used. The configuration of the apparatus is as follows:
Distillation Pot: A heating distillation apparatus consisting of a glass reactor, a mechanical stirrer, an oil heating jacket, and an insulating jacket
Distillation Column: A distillation column filled with SUS-made packing material (height: 150 cm, packing material: SUS-made packing material 0.24ProrPack (CANNON INSTRUMENT Co., Ltd.), number of theoretical number of plates: 16 stageplates (calculated value in n-heptane/methylcyclohexane system), HETP: 1.50 (m)/16 (plates)=0.094 (m/plate)), a fractionation head with a timer, a cooling condenser, a reflux line, and a distillation receiver connected. A sheet-shaped heater capable of heating the entire distillation column is installed. In addition, insulating material for insulation is wrapped around the outside of the heater.
Upper Outlet: The highest distillate outlet in the vertical direction of the distillation column
Distillate Outlet: Distillate outlets connected to the receiving trays installed in the distillation column at six different heights are attached. There is an open-close cock (valve) (valve) at each distillate outlet. The number of theoretical plates and the height from the bottom of the distillation column for each distillate outlet are shown in the table.

### [Distillation Operation]

Stirring and reduced pressure conditions were set, and heating of the distillation pot was performed. It was confirmed that the following distillation conditions were stabilized. In addition, heating was performed using the sheet-shaped heater installed in the distillation column until the distillation conditions were reached, and heating by the heater was stopped after the distillation conditions were reached.

### (Distillation Conditions) 10 g

Reflux ratio 80
Jacket temperature 112° C., internal temperature 105° C., condenser cooling temperature 52° C., top temperature (head)₆₈° C.
Top pressure (head)_{3.0} torr

Pressure loss in the distillation column 5.7 torr

After that, with the cock (valve) of the upper outlet closed, fraction outlet 1 was opened and a sample was collected for one hour. Distillate outlet 1 was then closed, the distillate outlet 2 was opened and a sample was collected for one hour. In a similar fashion, distillates were collected from outlets 3, 4, 5, and 6, one at a time, each for one hour. For each outlet, a sample of about 10 g was collected. It took 7 hours to collect all of the samples (6 hour collection time, in addition to time for opening and closing the valves, etc. Next, the cock (valve) of the upper outlet was opened and 40 g of the liquid distilled from the fractionation head was collected in the distillation receiver. The obtained samples are shown in the following table, and the impurities in each sample are shown in the table below.

TABLE 4

| | | | | Ratio of a number | | | |
|---|---|---|---|---|---|---|---|
| | | | Number of | of theoretical plates | | | |
| | | Height | theoretical | to a total number of | Compound (1) | Compound (2) | Compound (3) |
| | Sample | [cm] | plates | theoretical plates | iPrSn(NMe₂)₃ | iPr₂Sn(NMe₂)₂ | Sn(NMe₂)₄ |
| Before distillation | | — | — | — | 95.12% | 1.05% | 0.56% |
| After | Upper outlet | 150 | 16 | 1 | 87.47% | 0.05% | 9.27% |
| distillation | Distillate | 120 | 12.8 | 0.8 | 93.63% | 0.05% | 6.02% |
| | outlet 6 | | | | | | |
| | Distillate | 100 | 10.7 | 0.67 | 96.97% | 0.11% | 2.46% |
| | outlet 5 | | | | | | |
| | Distillate | 80 | 8.5 | 0.53 | 98.00% | 0.20% | 1.51% |
| | outlet 4 | | | | | | |
| | Distillate | 60 | 6.4 | 0.4 | 98.73% | 0.38% | 0.64% |
| | outlet 3 | | | | | | |
| | Distillate | 40 | 4.3 | 0.27 | 98.41% | 0.76% | 0.47% |
| | outlet 2 | | | | | | |
| | Distillate | 20 | 2.1 | 0.13 | 98.02% | 1.29% | 0.41% |
| | outlet 1 | | | | | | |
| | Distillation | 0 | 0 | 0 | 70.58% | 1.73% | 0.57% |
| | pot | | | | | | |

High-purity tin compound (1) was obtained from the distillates collected from distillate outlets 1 to 5. On the other hand, the sample from the distillation receiver collected from the upper outlet, which is the highest distillate outlet in the vertical direction of the distillation column, contained a large amount of tetramide compound (3), and it was not possible to obtain high-purity tin compound (1). The purity of tin compound (1) remaining in the distillation pot was 70.6%, and it was not possible to obtain high-purity tin compound (1) from the distillation pot.

The above examples provide specific embodiments of the present invention, but they are merely examples and should not be interpreted restrictively. Various modifications that are obvious to those skilled in the art are intended to be included within the scope of the present invention.

1. A method for producing a tin compound having formula (A1) and having a purity of 95 mol % or more, the method comprising a step of distilling the tin compound,
wherein in the distillation step, a number of distillation plates is 10 or more and a reflux ratio is 30 or less: 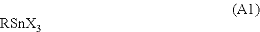
wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms, when there are multiple R′ groups in the molecule, they may be the same or different in structure, and they may also be bonded to form a cyclic structure.

2. The method for producing the tin compound according to claim 1, wherein a distillation time is 1 to 20 hours.

3. A method for producing a tin compound having formula (A1) and having a purity of 95 mol % or more, the method comprising a step of distilling the tin compound,
wherein the distillation step includes the following operations 1 and 2: 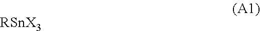
wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms; when there are multiple R′ groups in the molecule, they may be the same or different in structure, and they may also be bonded to form a cyclic structure.
operation 1:
withdrawing an initial distillate, which corresponds to 0.1-50% by mass of a total distillate, under conditions when a reflux ratio is less than or equal to 1;
operation 2:
withdrawing a remaining distillate, excluding the initial distillate from operation 1, under conditions when the reflux ratio exceeds 1.

4. The method for producing the tin compound according to claim 3, wherein a distillation rate in operation 1 is higher than a distillation rate in operation 2.

5. The method for producing the tin compound according to claim 3, wherein the reflux ratio in operation 2 is 5-100.

6. A method for producing a tin compound having formula (A1) and having a purity of 95 mol % or more, the method comprising a step of distilling the tin compound,
wherein the distillation step employs a heating vessel having a heat transfer area of 1.0 cm²/g or less per mass of the tin compound: 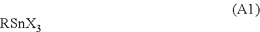
wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms; when there are multiple R′ groups in the molecule, they may be the same or different in structure, and they may also be bonded to form a cyclic structure.

7. A method for producing a tin compound having formula (A1) and having a purity of 95 mol % or more, the method comprising a step of distilling the tin compound, wherein the distillation step employs a distillation tower having multiple distillate outlets, and wherein the tin compound (A1) is obtained from a distillate outlet located below the highest outlet in a vertical direction of the distillation tower: 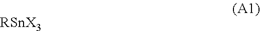
wherein R is an organic group with 1 to 30 carbon atoms, which may be partially substituted with halogen, oxygen, or nitrogen atoms, X is selected from OR′ or NR′₂, R′ is an organic group with 1 to 10 carbon atoms, which may be partially substituted with halogen, oxygen, or nitrogen atoms, when there are multiple R′ groups in the molecule, they may be the same or different in structure, and they may also be bonded to form a cyclic structure.

8. The method for producing the tin compound according to claim 7, wherein a ratio of the number of theoretical plates below the highest distillate outlet in the vertical direction of the distillation tower to the total number of plates in the distillation tower is 0.01-0.75.

9. The method for producing the tin compound according to claim 7, wherein the number of theoretical plates for the distillate outlet located below the highest outlet in the vertical direction of the distillation tower is 1 or more.

10. A method for producing a tin compound having formula (A1) and having a purity of 95 mol % or more, the method comprising a step of distilling the tin compound, wherein the distillation step employs a packed distillation tower equipped with insulation equipment and/or heating equipment: 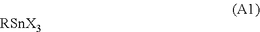
wherein R is an organic group with 1 to 30 carbon atoms, which may be partially substituted with halogen, oxygen, or nitrogen atoms. X is selected from OR′ or NR′₂, R′ is an organic group with 1 to 10 carbon atoms, which may be partially substituted with halogen, oxygen, or nitrogen atoms, when there are multiple R′ groups in the molecule, they may be the same or different in structure, and they may also be bonded to form a cyclic structure.

11. The method for producing the tin compound according to claim 10, wherein an HETP (m/plate) of a regular packing material in the distillation tower used in the distillation step is 0.5 or less.

12. The method for producing the tin compound according to claim 3, wherein the purity of the tin compound having formula (A1) is 98 mol % or more.

13. The method for producing the tin compound according to claim 3, wherein a content of SnX₄ (A3) is 1 mol % or less.

14. The method for producing the tin compound according to claim 3, wherein a content of R₂SnX₂ (A2) is 1 mol % or less.

15. The method for producing the tin compound according to claim 3, wherein a content of a compound having formula (A4) is 1 mol % or less. 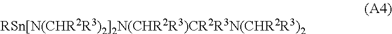
wherein R² and R³ are independently hydrogen atoms or organic groups with 1 to 10 carbon atoms, which may be partially substituted with halogen, oxygen, or nitrogen atoms, and wherein R² and R³ may be bonded to form a cyclic structure.

16. The method for producing the tin compound according to claim 3, wherein a molecular weight difference between R and X in the tin compound having formula (A1) is 30 or less.

17. The method for producing the tin compound according to claim 3, wherein the distillation step is performed as a batch distillation.

18. The method for producing the tin compound according to claim 3, wherein the packing material in the distillation tower used in the distillation step is a regular packing material.

19. The method for producing the tin compound according to claim 3, wherein an HETP (m/plate) of the packing material in the distillation tower used in the distillation step is 0.5 or less.

20. The method for producing the tin compound according to claim 3, wherein a distillation tower used in the distillation step is equipped with insulation equipment and/or heating equipment.

21. The method for producing the tin compound according to claim 3, wherein a difference between the jacket temperature and the distillation temperature (internal temperature) in the distillation step is 3-40° C.

22. The method for producing the tin compound according to claim 3, wherein a distillation temperature in the distillation step is 50° C. or higher.

23. The method for producing the tin compound according to claim 3, wherein the distillation step is performed under a reduced pressure of 10 torr or less.

24. The method for producing the tin compound according to claim 3, wherein a cooling condenser with a temperature 10-70° C. lower than a boiling point of the tin compound having formula (A1) is used in the distillation step.

25. The method for producing the tin compound according to claim 3, wherein a stirring speed in the distillation step is 100 rpm or more.

26. The method for producing the tin compound according to claim 3, wherein a distillation time in the distillation step is 10-100 hours.

27. The method for producing the tin compound according to claim 3, wherein a distillation rate in the distillation step is 1%/h or more,
wherein the distillation rate is based on an extraction rate:
$$Extraction rate ( \% ) = Extraction mass ( g ) / Charged mass ( g ) \times 100$$
$$Distillation rate ( \% / h ) = Extraction rate ( \% ) / Extraction time ( h ) .$$

28. The method for producing the tin compound according to claim 3, wherein the distillation step is performed under light-shielding conditions.

29. The method for producing the tin compound according to claim 3, wherein the tin compound obtained after the distillation step is filled into a storage container under an inert atmosphere.

30-37. (canceled)
